(19) United States
(12) Patent Application Publication
(10) Pub. No.: US 2015/0054417 A1
(43) Pub. Date: Feb. 26, 2015

(54) LED DRIVING DEVICE AND LIGHTING DEVICE

(71) Applicant: SAMSUNG ELECTRONICS CO., LTD., Suwon-si (KR)

(72) Inventor: Bong Jin LEE, Hwaseong-si (KR)

(73) Assignee: SAMSUNG ELECTRONICS CO., LTD.

(21) Appl. No.: 14/328,495

(22) Filed: Jul. 10, 2014

(30) Foreign Application Priority Data
Aug. 21, 2013 (KR) 10-2013-0099275

(51) Int. Cl. H05B 33/08

(52) U.S. Cl. CPC H05B 33/0815; H05B 33/0872; H05B 33/086
USPC 315/201

(57) ABSTRACT

The disclosed implementations include a light emitting diode (LED) driving device including a DC-DC converter generating a driving signal with respect to a plurality of LEDs, a rectifying unit rectifying an alternating current (AC) signal to generate a direct current (DC) signal, a power factor correction (PFC) converter connected to the rectifying unit, and a controller detecting an output from the DC-DC converter and an output from the PFC converter to determine input impedance of the PFC converter.

### CROSS-REFERENCE TO RELATED APPLICATIONS

This application claims the benefit of Korean Patent Application No. 10-2013-0099275 filed on Aug. 21, 2013, with the Korean Intellectual Property Office, the disclosure of which is incorporated herein in its entirety by reference.

### BACKGROUND

The present disclosure relates to a light emitting diode (LED) driving device and a lighting device.

Light emitting diodes (LEDs) are commonly used as a light source due to various advantages such as low power consumption and high luminance. In particular, light emitting devices have recently been employed as backlights in lighting devices and large liquid crystal displays (LCDs). Light emitting devices like LEDs are provided as packages that may be easily installed in various devices, such as, lighting devices. As LEDs are increasingly used for illumination in various fields, compatibility of LEDs as substitutes for existing lighting devices has emerged as an important issue.

### SUMMARY

An embodiment of the present invention can provide an LED driving device capable of applying an existing LED to facilities for operating existing lighting fixtures such as a fluorescent lamp, an incandescent lamp, or the like.

According to an aspect of the disclosed embodiments, a light emitting diode (LED) driving device may include, but are not limited to: a DC-DC converter generating a driving signal with respect to a plurality of LEDs; a rectifying unit rectifying an alternating current (AC) signal to generate a direct current (DC) signal; a power factor correction (PFC) converter connected to the rectifying unit; and a controller detecting an output from the DC-DC converter and an output from the PFC converter to control input impedance of the PFC converter.

The controller may control the input impedance of the PFC converter on the basis of at least one of a level of the output from the PFC converter and a ripple component included in the output from the PFC converter.

In an embodiment, when the level of the output from the PFC converter or the ripple component included in the output from the PFC converter is increased, the controller may reduce the input impedance of the PFC converter, and when the level of the output from the PFC converter or the ripple component included in the output from the PFC converter is reduced, the controller may increase the input impedance of the PFC converter.

The controller may control the input impedance of the PFC converter by adjusting at least one of a switching frequency and a duty ratio of a switching element included in the PFC converter.

The controller may include, but is not limited to: an adding circuit adding the output from the PFC converter and a predetermined reference signal; and a Schmitt Trigger circuit controlling an operation of the switching element included in the PFC converter by using an output from the adding circuit and an output from the DC-DC converter.

A trigger voltage of the Schmitt Trigger circuit may be determined based on the level of the output from the PFC converter and the ripple component included in the output from the PFC converter.

The LED driving device may further include a diode connected between an output terminal of the PFC converter and an output terminal of the rectifying unit.

The AC signal rectified by the rectifying unit may be an output signal from a stabilizer including at least one of an electronic transformer and a magnetic transformer.

According to another aspect of the disclosed embodiments, a lighting device may include, but is not limited to: a light emitting unit including a plurality of light emitting diodes (LEDs); a transformer outputting an alternating current (AC) signal; a converter unit including a power factor correction (PFC) converter connected to an output terminal of the transformer and a DC-DC converter generating a driving signal for operating the plurality of LEDs; and a controller adjusting impedance matching between an input terminal of the PFC converter and the output terminal of the transformer by detecting an output from the PFC converter and a current flowing in the light emitting unit.

The controller may control an input impedance of the converter unit on the basis of a level of the output from the PFC converter and a ripple component included in the output from the PFC converter.

The controller may control an input impedance of the converter unit by controlling at least one of a switching frequency and a duty ratio of a switching element included in the PFC converter.

The controller may include, but is not limited to: an adding circuit adding the output from the PFC converter and a predetermined reference signal; and a Schmitt Trigger circuit controlling an operation of the switching element by using an output from the adding circuit and a current flowing in the light emitting unit.

A trigger voltage of the Schmitt Trigger circuit may be determined by the level of the output from the PFC converter and the ripple component included in the output from the PFC converter.

In an embodiment, when the level of the output from the PFC converter or the ripple component included in the output from the PFC converter is increased, the controller may increase a duty ratio of the switching element, and when the level of the output from the PFC converter or the ripple component included in the output from the PFC converter is reduced, the controller may reduce the duty ratio of the switching element.

The lighting device may further comprises a rectifying unit rectifying an alternating current (AC) signal output from the transformer, and a diode connected between an output terminal of the PFC converter and an output terminal of the rectifying unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram schematically illustrating an LED driving device according to an exemplary embodiment of the present disclosure;

FIG. 2 is a block diagram schematically illustrating a lighting device including an LED driving device according to an exemplary embodiment of the present disclosure;

FIG. 3 is a cross-sectional view schematically illustrating an example of a substrate employable in a light emitting unit of FIG. 2;

FIG. 4 is a cross-sectional view schematically illustrating another example of the substrate;

FIG. 5 is a cross-sectional view schematically illustrating a modification of the substrate of FIG. 4;

FIGS. 6 through 9 are cross-sectional views schematically illustrating various examples of the substrate;

FIG. 10 is a cross-sectional view schematically illustrating an example of a light emitting device (or an LED) employable in a light emitting unit of FIG. 2;

FIG. 11 is a cross-sectional view schematically illustrating another example of a light emitting device (or an LED) employable in the light emitting unit of FIG. 2;

FIG. 12 is a cross-sectional view schematically illustrating another example of a light emitting device (or an LED) employable in the light emitting unit of FIG. 2;

FIG. 13 is a cross-sectional view illustrating an example of an LED chip as a light emitting device employable in the light emitting unit of FIG. 2, mounted on a mounting board;

FIGS. 14 through 16 are circuit diagrams illustrating a lighting device according to an exemplary embodiment of the present disclosure;

FIGS. 17A and 17B are waveform graphs illustrating an operation of the LED driving device according to an exemplary embodiment of the present disclosure;

FIG. 18 is a waveform graph illustrating an operation of the LED driving device according to an exemplary embodiment of the present disclosure;

FIG. 19 is a block diagram schematically illustrating a lighting system according to an exemplary embodiment of the present disclosure;

FIG. 20 is a block diagram schematically illustrating a detailed configuration of a lighting unit of the lighting system illustrated in FIG. 19;

FIG. 21 is a flow chart illustrating a method for controlling the lighting system illustrated in FIG. 19;

FIG. 22 is a view schematically illustrating the way in which the lighting system illustrated in FIG. 19 is used;

FIG. 23 is a block diagram of a lighting system according to another exemplary embodiment of the present disclosure;

FIG. 24 is a view illustrating a format of a ZigBee signal employable in a lighting system according to an exemplary embodiment of the present disclosure;

FIG. 25 is a view illustrating a sensing signal analyzing unit and an operation control unit according to an exemplary embodiment of the present disclosure;

FIG. 26 is a flow chart illustrating an operation of a wireless lighting system according to an exemplary embodiment of the present disclosure;

FIG. 27 is a block diagram schematically illustrating components of a lighting system according to another exemplary embodiment of the present disclosure;

FIG. 28 is a flow chart illustrating a method of controlling a lighting system according to an exemplary embodiment of the present disclosure;

FIG. 29 is a flow chart illustrating a method of controlling a lighting system according to another exemplary embodiment of the present disclosure; and

FIG. 30 is a flow chart illustrating a method of controlling a lighting system according to another exemplary embodiment of the present disclosure.

FIG. 31 is an exploded perspective view schematically illustrating a lighting device according to an exemplary embodiment of the present disclosure;

FIG. 32 is a cross-sectional view schematically illustrating a lighting device according to an exemplary embodiment of the present disclosure; and

FIG. 33 is an exploded perspective view schematically illustrating a lighting device according to an exemplary embodiment of the present disclosure.

### DETAILED DESCRIPTION

Hereinafter, exemplary embodiments of the present disclosure will be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

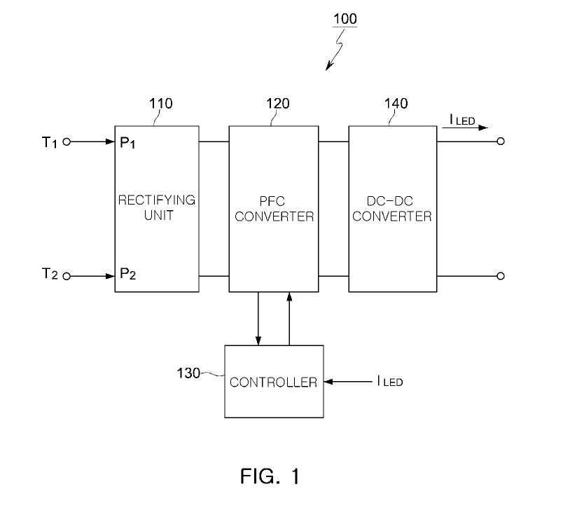

FIG. 1 is a block diagram schematically illustrating an LED driving device according to an exemplary embodiment of the present disclosure.

Referring to FIG. 1, an LED driving device 100 according to an exemplary embodiment of the present disclosure may include a rectifying unit 110, a power factor correction (PFC) converter 120, a controller 130, a DC-DC converter 140, and the like. The rectifying unit 110 converts alternating current (AC) signals applied from terminals T₁ and T₂ connected to input terminals P₁ and P₂ of the LED driving device 100 into direct current (DC) signals. For example, the rectifying unit 110 may include a diode bridge circuit. An output terminal of an electromagnetic or self-excited transformer included in a ballast (or a stabilizer) used for driving a halogen lamp may be connected to the input terminals P₁ and P₂ of the LED driving device 100.

In an embodiment, the DC signals output by the rectifying unit 110 may be delivered to the PFC converter 120. The PFC converter 120 may include at least one switching element, and input impedance of the LED driving device 100 may be determined by at least one of a switching frequency and a duty ratio of the switching element included in the PFC converter 120.

In an embodiment, the controller 130 may control at least one of the switching frequency and the duty ratio of the switching element included in the PFC converter 120. The controller 130 may detect an output voltage from the PFC converter 120 and a current I_{LED} flowing in an LED connected to the DC-DC converter 140 to control an operation of the switching element included in the PFC converter 120. A circuit configuration of the controller 130, a control method of the PFC converter 120, and the like, will be described further below.

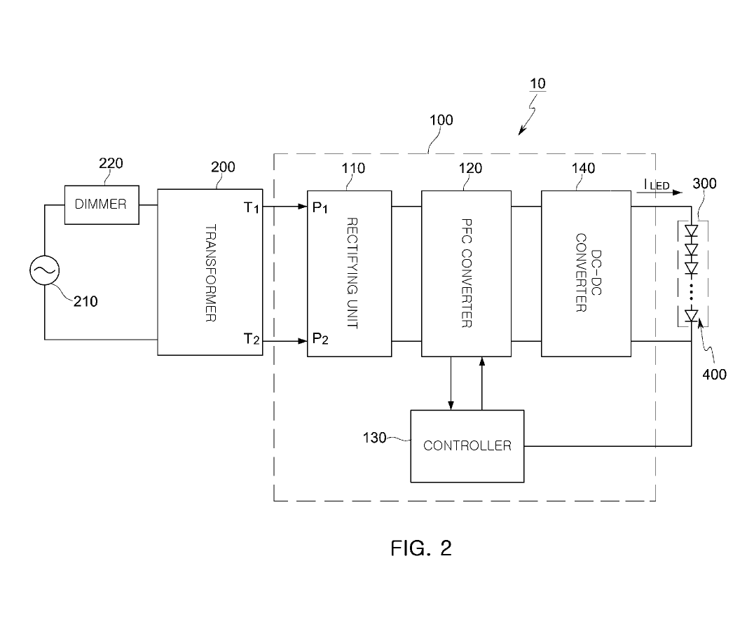

FIG. 2 is a block diagram schematically illustrating a lighting device including an LED driving device according to an exemplary embodiment of the present disclosure.

Referring to FIG. 2, a lighting device 10 according to the exemplary embodiment of the present disclosure may include the LED driving device 100, a transformer 200, a light emitting unit 300, and the like. The light emitting unit 300 may include a plurality of light emitting elements 400, for example, a plurality of LEDs. The transformer 200 may step down an AC source signal output from an AC power source 210 and deliver the same to the LED driving device 100. A dimmer 220 for regulating luminance of light output by the light emitting unit 300 may be selectively connected between the AC power source 210 and the transformer 200.

In an embodiment, the AC power source 210 may be a general commercial AC power source, and the dimmer 220 may operate in either a trailing edge manner or a leading edge manner. The transformer 200 may be a magnetic or electronic transformer. For example, the transformer 200 may be equipment for supplying an AC signal for driving a halogen lamp as a resistive load. The light emitting unit 300 including a plurality of light emitting elements 400 may be operated by the LED driving device 100 that outputs a DC signal appropriate for driving the light emitting elements 400 from an AC signal output by the transformer 200.

Unlike a case in which the halogen lamp acts a resistive load connected to the output terminals T₁ and T₂ of the transformer 200, in the exemplary embodiment of the present disclosure in which the LED driving device 100 operating in a switching mode power supply (SMPS) manner and the light emitting unit 300 including the plurality of light emitting elements 400 are connected, input impedance of the LED driving device 100 may vary. Namely, an amount of power applied to the input terminals P₁ and P₂ of the LED driving device 100 may need to be regulated by adjusting the input impedance of the LED driving device 100 according to a change in an output from the transformer 200.

In an embodiment, the LED driving device 100 may generate a DC signal for driving the light emitting elements 400 in an SMPS manner. The LED driving device 100 may include the rectifying unit 110, the PFC converter 120, the controller 130 that controls an operation of the PFC converter 120, the DC-DC converter 140 that steps down the DC signal generated by the rectifying unit 110 to have a level appropriate for driving the light emitting elements 400, and the like.

In an embodiment, the light emitting unit 300 may include the plurality of light emitting elements 400 and a board (or a substrate) on which the plurality of light emitting elements 400 are mounted. Hereinafter, various embodiments of the board and the light emitting elements 400 that may be included in the light emitting unit 300 will be described.

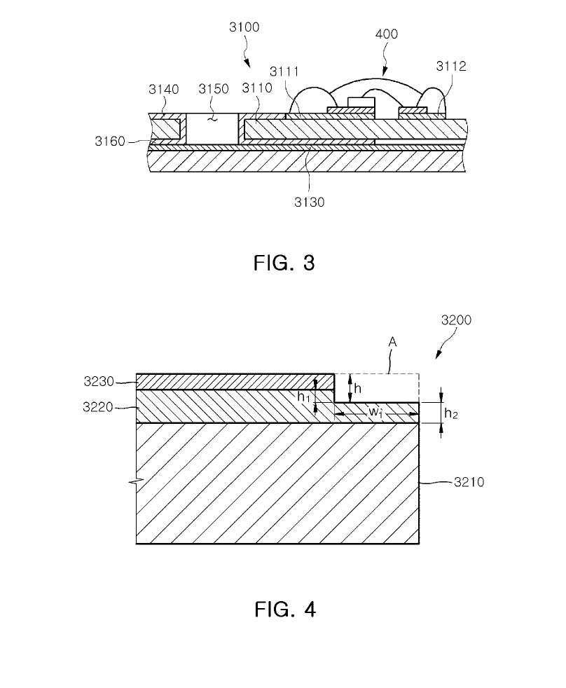

First, various embodiments of the substrate that may be included in the light emitting unit 300 will be described with reference to FIGS. 3 through 9.

As illustrated in FIG. 3, a substrate 3100 may include an insulating substrate 3110 including predetermined circuit patterns 3111 and 3112 formed on one surface thereof, an upper thermal diffusion plate 3140 formed on the insulating substrate 3110 such that the upper thermal diffusion plate 3140 is in contact with the circuit patterns 3111 and 3112, and dissipating heat generated by the light emitting element 400, and a lower thermal diffusion plate 3160 formed on the other surface of the insulating substrate 3110 and transmitting heat, transmitted from the upper thermal diffusion plate 3140, outwardly. The upper thermal diffusion plate 3140 and the lower thermal diffusion plate 3160 may be connected by at least one through hole 3150 that penetrates through the insulating substrate 3110 and has plated inner walls, so as to be conduct heat between the upper thermal diffusion plate 3140 and the lower thermal diffusion plate 3160.

In the insulating substrate 3110, the circuit patterns 3111 and 3112 may be formed by cladding a ceramic with copper or epoxy resin-based FR4 and performing an etching process thereon. An insulating thin film 1130 may be formed by coating an insulating material on a lower surface of the substrate 3110.

FIG. 4 illustrates another example of a substrate. As illustrated in FIG. 4, a substrate 3200 includes a first metal layer 3210, an insulating layer 3220 formed on the first metal layer 3210, and a second metal layer 3230 formed on the insulating layer 3220. A step region ‘A’ allowing the insulating layer 3220 to be exposed may be formed in at least one end portion of the substrate 3200.

In an embodiment, the first metal layer 3210 may be made of a material having excellent exothermic characteristics. For example, the first metal layer 3210 may be made of a metal such as aluminum (Al), iron (Fe), or the like, or an alloy of these metals. The first metal layer 3210 may have a unilayer structure or a multilayer structure. The insulating layer 3220 may be made of a material having insulating properties, and may be formed with an inorganic material or an organic material. For example, the insulating layer 3220 may be made of an epoxy-based insulating resin, and may include metal powder such as aluminum (Al) powder, or the like, in order to enhance thermal conductivity. The second metal layer 3230 may generally be formed of a copper (Cu) thin film.

As illustrated in FIG. 4, in the metal substrate according to the present embodiment, a length of an exposed region at one end portion of the insulating layer 3220, i.e., an insulation length, may be greater than a thickness of the insulating layer 3220. In the present embodiment, the insulation length can refer to a length of the exposed region of the insulating layer 3220 between the first metal layer 3210 and the second metal layer 3230. When the metal substrate 3200 is viewed from above, a width of the exposed region of the insulating layer 3220 is an exposure width W1. The region ‘A’ in FIG. 4 can be removed through a grinding process, or the like, during the manufacturing process of the metal substrate. The region as deep as a depth ‘h’ downwardly from a surface of the second metal layer 3230 is removed to expose the insulating layer 3220 by the exposure width W1, forming a step structure. If the end portion of the metal substrate 3200 is not removed, the insulation length may be equal to a thickness (h1+h2) of the insulating layer 3220, and by removing a portion of the end portion of the metal substrate 3200, an insulation length equal to approximately W1 may be additionally secured. Thus, when a withstand voltage of the metal substrate 3200 is tested, the likelihood of contact between the two metal layers 3210 and 3230 in the end portions thereof is minimized.

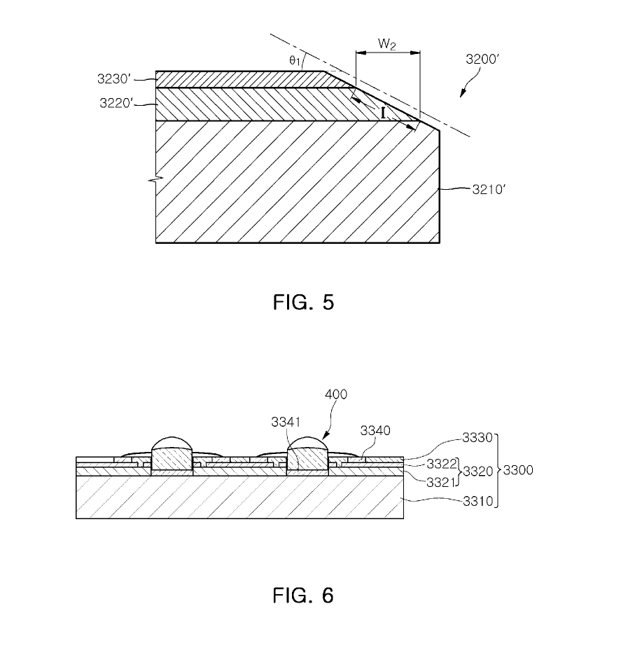

FIG. 5 is a view schematically illustrating a structure of a metal substrate according to a modification of FIG. 4. Referring to FIG. 5, a metal substrate 3200′ includes a first metal layer 3210′, an insulating layer 3220′ formed on the first metal layer 3210′, and a second metal layer 3230′ formed on the insulating layer 3220′. The insulating layer 3220′ and the second metal layer 3230′ include regions removed at a predetermined tilt angle θ1, and the first metal layer 3210′ may also include a region removed at the predetermined tilt angle θ1.

Here, the tilt angle θ1 may be an angle between an interface between the insulating layer 3220′ and the second metal layer 3230′ and an end portion of the insulating layer 3220′. The tilt angle θ1 may be selected to secure a desired insulation length I in consideration of a thickness of the insulating layer 3220′. The tilt angle θ1 may be selected from within the range of 0<θ1<90 (degrees). As the tilt angle θ1 is increased, the insulation length I and a width W2 of the exposed region of the insulating layer 3220′ is increased, so in order to secure a larger insulation length, the tilt angle θ1 may be selected to be smaller. For example, the tilt angle may be selected from within the range of 0<θ1≦45 (degrees).

FIG. 6 schematically illustrates another example of a substrate. Referring to FIG. 6, a substrate 3300 includes a metal support substrate 3310 and resin-coated copper (RCC) 3320 formed on the metal support substrate 3310. The RCC 3320 may include an insulating layer 3321 and a copper foil 3322 laminated on the insulating layer 3321. A portion of the RCC 3320 may be removed to form at least one recess in which the light emitting element 400 may be installed. The metal substrate 3300 has a structure in which the RCC 3320 is removed from a lower region of the light emitting element 400 and the light emitting element 400 is in direct contact with the metal support substrate 3310. Thus, heat generated by the light emitting element 400 is directly transmitted to the metal support substrate 3310, enhancing heat dissipation performance. The light emitting element 400 may be electrically connected to be fixed through solders 3340 and 3341. A protective layer 3330 made of a liquid photo solder resist (PSR) may be formed on an upper portion of the copper foil 3322.

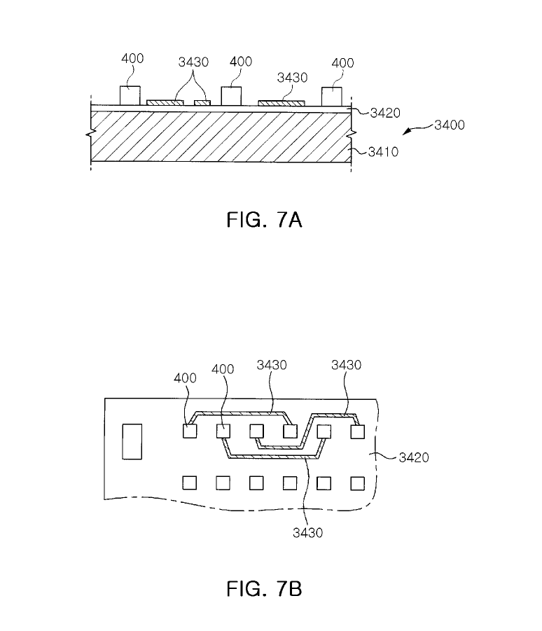

FIG. 7 schematically illustrates another example of the substrate. A substrate according to the present embodiment includes an anodized metal substrate having excellent heat dissipation characteristics and incurring low manufacturing costs. Referring to FIG. 7, the anodized metal substrate 3400 may include a metal plate 3410, an anodic oxide film 3420 formed on the metal plate 3410, and electrical wirings 3430 formed on the anodic oxide film 3420.

In an embodiment, the metal plate 3410 may be made of aluminum (Al) or an Al alloy that may be easily obtained at low cost. Besides, the metal plate 3410 may be made of any other anodizable metal, for example, a material such as titanium (Ti), magnesium (Mg), or the like.

Aluminum oxide film (Al₂O₃) 3420 obtained by anodizing aluminum has a relatively high heat transmission characteristics ranging from about 10 W/mK to 30 W/mK. Thus, the anodized metal substrate 3400 has superior heat dissipation characteristics to those of a PCB, an MCPCB, or the like, conventional polymer substrates.

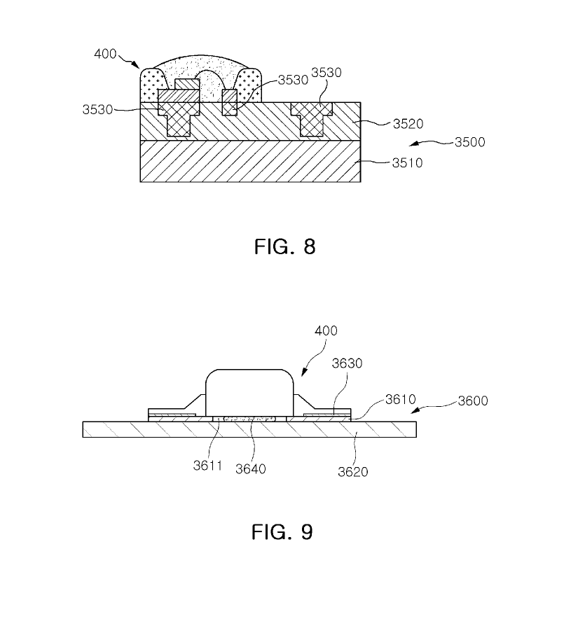

FIG. 8 schematically illustrates another example of the substrate. As illustrated in FIG. 8, a substrate 3500 may include a metal substrate 3510, an insulating resin 3520 coated on the metal substrate 3510, and a circuit pattern 3530 formed on the insulating resin 3520. Here, the insulating resin 3520 may have a thickness equal to or less than 200 μm. The insulating resin 3520 may be laminated on the metal substrate 3510 in the form of a solid film or may be coated in liquid form using spin coating or a blade. Also, the circuit pattern 3530 may be formed by filling a metal such as copper (Cu), or the like, in a circuit pattern intaglioed on the insulting layer 3520. The light emitting element 400 may be mounted to be electrically connected to the circuit pattern 3530.

In an embodiment, the substrate may include a flexible PCB (FPCB) that can be freely deformed. As illustrated in FIG. 9, a substrate 3600 includes a flexible circuit board 3610 having one or more through holes 1611, and a support substrate 3620 on which the flexible circuit board 3610 is mounted. A heat dissipation adhesive 3640 may be provided in the through hole 1611 to couple a lower surface of the light emitting element 400 and an upper surface of the support substrate 3620. Here, the lower surface of the light emitting element 400 may be a lower surface of a chip package, a lower surface of a lead frame having an upper surface on which a chip is mounted, or a metal block. A circuit wiring 3630 is formed on the flexible circuit board 3610 and electrically connected to the light emitting element 400.

In this manner, because the flexible circuit board 3610 is used, thickness and weight can be reduced. This results in reduced thickness and weight and reduced manufacturing costs, Furthermore, because the light emitting element 400 is directly bonded to the support substrate 3620 by the heat dissipation adhesive 3640, heat dissipation efficiency in dissipating heat generated by the light emitting element 400 can be increased.

Hereinafter, various LED packages and various LED chips as light emitting devices employable in the light source module according to an embodiment of the present invention will be described.

### Light Emitting Device

### First Example

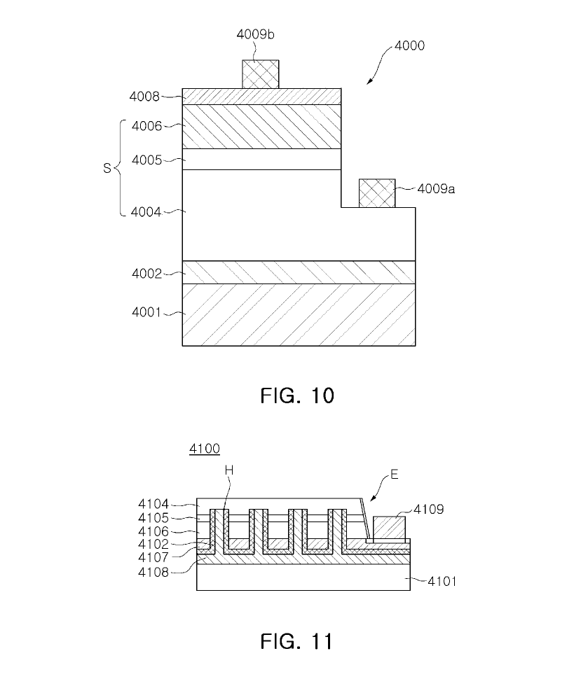

FIG. 10 is a side cross-sectional view schematically illustrating an example of a light emitting device (an LED chip).

As illustrated in FIG. 10, a light emitting element 4000 may include a light emitting laminate S formed on a growth substrate 4001. The light emitting laminate S may include a first conductivity-type semiconductor layer 4004, an active layer 4005, and a second conductivity-type semiconductor layer 4006.

An ohmic-contact layer 4008 may be formed on the second conductivity-type semiconductor layer 4006, and first and second electrodes 4009a and 4009b may be formed on upper surfaces of the first conductivity-type semiconductor layer 4004 and the ohmic-contact layer 4008, respectively.

In the present disclosure, terms such as ‘upper portion’, ‘upper surface’, ‘lower portion’, ‘lower surface’, ‘lateral surface’, and the like, are determined based on the drawings, and in actuality, the terms may be changed according to a direction in which a light emitting device is disposed.

Hereinafter, major components of the light emitting device will be described.

Substrate

A substrate including a light emitting device is a growth substrate for epitaxial growth. An insulating substrate, a conductive substrate, or a semiconductor substrate may be used as the substrate 4001. For example, sapphire, SiC, Si, MgAl₂O₄, MgO, LiAlO₂, LiGaO₂, or GaN may be used as a material of the substrate 4001. For epitaxial growth of a GaN material, a GaN substrate, a homogeneous substrate, may be desirable, but it can incur high production costs due to difficulties in its manufacturing process.

As a heterogeneous substrate, a sapphire substrate, a silicon carbide substrate, or the like, is largely used, and in this case, a sapphire substrate is utilized relatively more than the costly silicon carbide substrate. When a heterogeneous substrate is used, defects such as dislocation, and the like, may be increased due to differences in lattice constants between a substrate material and a thin film material. Also, differences in coefficients of thermal expansion between the substrate material and the thin film material may cause bowing due to changing temperatures, and the bowing may cause cracks in the thin film. This problem may be reduced by using a buffer layer 4002 between the substrate 4001 and the light emitting laminate S based on GaN.

In an embodiment, the substrate 4001 may be fully or partially removed or patterned during a chip manufacturing process in order to enhance optical or electrical characteristics of the LED chip before or after the light emitting laminate S is grown.

For example, a sapphire substrate may be separated by irradiating a laser on the interface between the substrate and a semiconductor layer through the substrate, and a silicon substrate or a silicon carbide substrate may be removed through a method such as polishing, etching, or the like.

In removing the substrate, a support substrate may be used, and in this case, in order to enhance luminance efficiency of an LED chip on the opposite side of the original growth substrate, the support substrate may be bonded by using a reflective metal or a reflective structure may be inserted into the center of a junction layer.

Substrate patterning can form a concavo-convex surface or a sloped surface on a main surface (one surface or both surfaces) or lateral surfaces of a substrate before or after the growth of the light emitting laminate S, enhancing light extraction efficiency. A pattern size may be selected within the range from 5 nm to 500 μm. The substrate may have any structure as long as it has a regular or irregular pattern to enhance light extraction efficiency. The substrate may have various shapes such as a columnar shape, a peaked shape, a hemispherical shape, a polygonal shape, and the like.

Here, the sapphire substrate is a crystal having Hexa-Rhombo R3c symmetry, of which lattice constants in c-axial and a-axial directions are approximately 13.001 Å and 4.758 Å, respectively, and has a C-plane (0001), an A-plane (1120), an R-plane (1102), and the like. In this case, the C-plane of sapphire crystal allows a nitride thin film to be relatively easily grown thereon and is stable at high temperatures, so the sapphire substrate can be commonly used as a nitride growth substrate.

In an embodiment, the substrate 4001 may also be made of silicon (Si). Since a silicon (Si) substrate can be more appropriate for increasing a diameter and is relatively low in price, it may be used to facilitate mass-production. Here, a difference in lattice constants between the silicon substrate having (111) plane as a substrate surface and GaN is approximately 17%, requiring a technique of suppressing the generation of crystal defects due to the difference between the lattice constants. Also, a difference in coefficients of thermal expansion between silicon and GaN is approximately 56%, requiring a technique of suppressing bowing of a wafer generated due to the difference in the coefficients of thermal expansion. Bowed wafers may result in cracks in the GaN thin film and make it difficult to control processes to increase dispersion of emission wavelengths (or excitation wavelengths) of light in the same wafer, or the like.

The silicon substrate absorbs light generated in the GaN-based semiconductor, lowering external quantum yield of the light emitting device. Thus, the substrate may be removed and a support substrate such as a silicon substrate, a germanium substrate, an SiAl substrate, a ceramic substrate, a metal substrate, or the like. A reflective layer may be additionally formed to be used, as necessary.

Buffer Layer

When a GaN thin film is grown on a heterogeneous substrate such as the silicon substrate, dislocation density may be increased due to a lattice constant mismatch between a substrate material and a thin film material, and cracks and warpage (or bowing) may be generated due to a difference between coefficients of thermal expansion. In order to prevent dislocation of and cracks in the light emitting laminate S, the buffer layer 4002 may be disposed between the substrate 1001 and the light emitting laminate S. The buffer layer 1002 may serve to adjust a degree of warpage of the substrate when an active layer is grown, to reduce a wavelength dispersion of a wafer.

The buffer layer 4002 may be made of AlₓIn_{y}Ga_{1-x-y}N (0≦x≦1, 0≦y≦1, 0≦x+y≦1), in particular, GaN, AlN, AlGaN, InGaN, or InGaNAlN, and a material such as ZrB₂, HfB₂, ZrN, HfN, TiN, or the like, may also be used as necessary. Also, the buffer layer may be formed by combining a plurality of layers or by gradually changing a composition.

A silicon (Si) substrate has a coefficient of thermal expansion significantly different from that of GaN. Thus, in the case of growing a GaN-based thin film on the silicon substrate, when a GaN thin film is grown at a high temperature and is subsequently cooled to room temperature, tensile stress is applied to the GaN thin film due to the difference in the coefficients of thermal expansion between the silicon substrate and the GaN thin film may generate cracks. In this case, in order to prevent the generation of cracks, a method of growing the GaN thin film such that compressive stress is applied to the GaN thin film while the GaN thin film is being grown is used to compensate for tensile stress.

A difference in the lattice constants between silicon (Si) and GaN involves a high possibility of a defect being generated. In the case of a silicon substrate, a buffer layer having a composite structure may be used in order to control stress for restraining warpage (or bowing) as well as controlling a defect.

For example, first, an AlN layer is formed on the substrate 4001. In this case, a material not including gallium (Ga) may be used in order to prevent a reaction between silicon (Si) and gallium (Ga). Besides AlN, a material such as SiC, or the like, may also be used. The AlN layer is grown at a temperature ranging from 400° C. to 1,300° C. by using an aluminum (Al) source and a nitrogen (N) source. An AlGaN intermediate layer may be inserted into the center of GaN between the plurality of AlN layers to control stress, as necessary.

Light Emitting Laminate

The light emitting laminate S having a multilayer structure of a Group III nitride semiconductor will be described in detail. The first and second conductivity-type semiconductor layers 4004 and 4006 may be formed of n-type and p-type impurity-doped semiconductor materials, respectively.

However, the present invention is not limited thereto and, conversely, the first and second conductivity-type semiconductor layers 4004 and 4006 may be formed of p-type and n-type impurity-doped semiconductor materials, respectively. For example, the first and second conductivity-type semiconductor layers 4004 and 4006 may be made of a Group III nitride semiconductor, e.g., a material having a composition of AlₓIn_{y}Ga_{1-x-y}N (0≦x≦1, 0≦y≦1, 0≦x+y≦1). Of course, the present invention is not limited thereto and the first and second conductivity-type semiconductor layers 4004 and 4006 may also be made of a material such as an AlGaInP-based semiconductor or an AlGaAs-based semiconductor.

In an embodiment, the first and second conductivity-type semiconductor layers 4004 and 4006 may have a unilayer structure, or, alternatively, the first and second conductivity-type semiconductor layers 4004 and 4006 may have a multilayer structure including layers having different compositions, thicknesses, and the like, as necessary. For example, the first and second conductivity-type semiconductor layers 4004 and 4006 may have a carrier injection layer for improving electron and hole injection efficiency, or may have various types of superlattice structure, respectively.

In an embodiment, the first conductivity-type semiconductor layer 4004 may further include a current spreading layer (not shown) in a region adjacent to the active layer 4005. The current spreading layer may have a structure in which a plurality of InₓAl_{y}Ga_{(1-x-y)}N layers having different compositions or different impurity contents are iteratively laminated or may have an insulating material layer partially formed therein.

The second conductivity-type semiconductor layer 4006 may further include an electron blocking layer in a region adjacent to the active layer 4005. The electron blocking layer may have a structure in which a plurality of InₓAl_{y}Ga_{(1-x-y)}N layers having different compositions are laminated or may have one or more layers including Al_{y}Ga_{(1-y)}N. The electron blocking layer has a bandgap wider than that of the active layer 4005, thus preventing electrons from being transferred via the second conductivity-type (p-type) semiconductor layer 4006.

The light emitting laminate S may be formed by using metal-organic chemical vapor deposition (MOCVD). In order to fabricate the light emitting laminate S, an organic metal compound gas (e.g., trimethyl gallium (TMG), trimethyl aluminum (TMA)) and a nitrogen-containing gas (ammonia (NH₃), or the like) are supplied to a reaction container in which the substrate 4001 is installed as reactive gases, the substrate being maintained at a high temperature ranging from 900° C. to 1,100° C., and while a gallium nitride-based compound semiconductor is being grown, an impurity gas is supplied as necessary to laminate the gallium nitride-based compound semiconductor as an undoped n-type or p-type semiconductor. Silicon (Si) is a well known n-type impurity and p-type impurity includes zinc (Zn), cadmium (Cd), beryllium (Be), magnesium (Mg), calcium (Ca), barium (Ba), and the like. Among these, magnesium (Mg) and zinc (Zn) may be mainly used.

Also, the active layer 4005 disposed between the first and second conductivity-type semiconductor layers 4004 and 4006 may have a multi-quantum well (MQW) structure in which a quantum well layer and a quantum barrier layer are alternately laminated. For example, in the case of a nitride semiconductor, a GaN/InGaN structure may be used, or a single quantum well (SQW) structure may also be used.

Ohmic-Contact Layer and First and Second Electrodes

The ohmic-contact layer 4008 may have a relatively high impurity concentration to have low ohmic-contact resistance to lower an operating voltage of the element and enhance element characteristics. The ohmic-contact layer 4008 may be formed of a GaN layer, a InGaN layer, a ZnO layer, or a graphene layer.

In an embodiment, the first or second electrode 4009a or 4009b may be made of a material such as silver (Ag), nickel (Ni), aluminum (Al), rhodium (Rh), palladium (Pd), iridium (Ir), ruthenium (Ru), magnesium (Mg), zinc (Zn), platinum (Pt), gold (Au), or the like, and may have a structure including two or more layers such as Ni/Ag, Zn/Ag, Ni/Al, Zn/Al, Pd/Ag, Pd/Al, Ir/Ag, Ir/Au, Pt/Ag, Pt/Al, Ni/Ag/Pt, or the like.

The LED chip illustrated in FIG. 10 has a structure in which first and second electrodes face the same surface as a light extraction surface, but it may also be implemented to have various other structures, such as a flipchip structure in which first and second electrodes face a surface opposite to a light extraction surface, a vertical structure in which first and second electrodes are formed on mutually opposing surfaces, a vertical and horizontal structure employing an electrode structure by forming several vias in a chip as a structure for enhancing current spreading efficiency and heat dissipation efficiency, and the like.

### Light Emitting Device

### Second Example

In case of manufacturing a large light emitting device for a high output, an LED chip illustrated in FIG. 11 having a structure promoting current spreading efficiency and heat dissipation efficiency may be provided.

As illustrated in FIG. 11, the LED chip 4100 may include a first conductivity-type semiconductor layer 4104, an active layer 4105, a second conductivity-type semiconductor layer 4106, a second electrode layer 4107, an insulating layer 4102, a first electrode 4108, and a substrate 4101, laminated sequentially. Here, in order to be electrically connected to the first conductivity-type semiconductor layer 4104, the first electrode layer 4108 includes one or more contact holes H extending from one surface of the first electrode layer 4108 to at least a partial region of the first conductivity-type semiconductor layer 4104 and electrically insulated from the second conductivity-type semiconductor layer 4106 and the active layer 4105. However, the first electrode layer 4108 is not an essential element in the present embodiment.

In an embodiment, contact hole H extends from an interface of the first electrode layer 4108, passing through the second electrode layer 4107, the second conductivity-type semiconductor layer 4106, and the first active layer 4105, to the interior of the first conductivity-type semiconductor layer 4104. The contact hole H extends at least to an interface between the active layer 4105 and the first conductivity-type semiconductor layer 4104, and preferably, extends to a portion of the first conductivity-type semiconductor layer 4104. However, the contact hole H is formed for electrical connectivity and current spreading, so the purpose of the presence of the contact hole H is achieved when it is in contact with the first conductivity-type semiconductor layer 4104. Thus, it is not necessary for the contact hole H to extend to an external surface of the first conductivity-type semiconductor layer 4104.

The second electrode layer 4107 formed on the second conductivity-type semiconductor layer 4106 may be selectively made of a material among silver (Ag), nickel (Ni), aluminum (Al), rhodium (Rh), palladium (Pd), iridium (Ir), ruthenium (Ru), magnesium (Mg), zinc (Zn), platinum (Pt), gold (Au), and the like, in consideration of a light reflecting function and an ohmic-contact function with the second conductivity-type semiconductor layer 4106, and may be formed by using a process such as sputtering, deposition, or the like.

The contact hole H may have a form penetrating the second electrode layer 4107, the second conductivity-type semiconductor layer 4106, and the active layer 4105 so as to be connected to the first conductivity-type semiconductor layer 4104. The contact hole H may be formed through an etching process, e.g., inductively coupled plasma-reactive ion etching (ICP-RIE), or the like.

The insulating layer 4102 is formed to cover a side wall of the contact hole H and a lower surface of the second electrode layer 4107. In this case, at least a portion of the first conductivity-type semiconductor layer 4104 may be exposed by the contact hole H. The insulating layer 4102 may be formed by depositing an insulating material such as SiO₂, SiOₓN_{y}, or SiₓN_{y}. The insulating layer 4102 may be deposited to have a thickness ranging from about 0.01 μm to 3 μm at a temperature equal to or lower than 500° C. through a chemical vapor deposition (CVD) process.

In an embodiment, first electrode layer 4108 including a conductive via formed by filling a conductive material is formed within the contact hole H. A plurality of conductive vias may be formed in a single light emitting device region. The amount of vias and contact areas thereof may be adjusted such that the area of the plurality of vias occupying on the plane of the regions in which they are in contact with the first conductivity-type semiconductor layer 4104 ranges from 1% to 5% of the area of the light emitting device region. A radius of the via on the plane of the region in which the vias are in contact with the first conductivity-type semiconductor layer 4104 may range, for example, from 5 μm to 50 μm, and the number of vias may be 1 to 50 per light emitting device region according to a width of the light emitting device region. Although different according to a width of the light emitting device region, three or more vias may be provided. A distance between the vias may range from 100 μm to 500 μm, and the vias may have a matrix structure including rows and columns. Preferably, the distance between the vias may range from 150 μm to 450 μm. If the distance between the vias is smaller than 100 μm, the amount of vias is increased to relatively reduce a light emitting area to lower luminous efficiency, and if the distance between the vias is greater than 500 μm, current spreading may suffer to degrade luminous efficiency. A depth of the contact hole H may range from 0.5 μm to 5.0 μm, although the depth of the contact hole H V may vary according to a thickness of the second conductivity-type semiconductor layer and the active layer.

Subsequently, the substrate 4101 is formed on the first electrode layer 4108. In this structure, the substrate 4101 may be electrically connected by the conductive via connected to the first conductivity-type semiconductor layer 4104.

The substrate 4101 may be made of a material including any one of Au, Ni, Al, Cu, W, Si, Se, GaAs, SiAl, Ge, SiC, AlN, Al₂O₃, GaN, AlGaN and may be formed through a process such as plating, sputtering, deposition, bonding, or the like.

In order to reduce contact resistance, the amount, a shape, a pitch, a contact area with the first and second conductivity-type semiconductor layers 4104 and 4106, and the like, of the contact hole H may be appropriately regulated. The contact holes H may be arranged to have various shapes in rows and columns to improve a current flow. Here, the second electrode layer 4107 may have one or more exposed regions in the interface between the second electrode layer 2017 and the second conductivity-type semiconductor layer 4106, i.e., an exposed region E. An electrode pad part 4109 connecting an external power source to the second electrode layer 4107 may be provided on the exposed region E.

In this manner, the LED chip 4100 illustrated in FIG. 11 may include the light emitting structure having the first and second main surfaces opposing one another and having the first and second conductivity-type semiconductor layers 4104 and 4106 providing the first and second main surfaces, respectively, and the active layer 4105 formed between the first and second main surfaces, the contact holes H connected to a region of the first conductivity-type semiconductor layer 4104 through the active layer 4105 from the second main surface, the first electrode layer 4108 formed on the second main surface of the light emitting structure and connected to a region of the first conductivity-type semiconductor layer 4104 through the contact holes H, and the second electrode layer 4107 formed on the second main surface of the light emitting structure and connected to the second conductivity-type semiconductor layer 4106. Here, any one of the first and second electrodes 4108 and 4107 may be drawn out in a lateral direction of the light emitting structure.

### Light Emitting Device

### Third Example

A lighting device using an LED provides improved heat dissipation characteristics, but in the aspect of overall heat dissipation performance, preferably, the lighting device employs an LED chip having a low heating value. As an LED chip satisfying such requirements, an LED chip including a nano-structure (hereinafter, referred to as a ‘nano-LED chip’) may be used.

Such a nano-LED chip includes a recently developed core/shell type nano-LED chip, which has a low binding density to generate a relatively low degree of heat, has increased luminous efficiency by increasing a light emitting region by utilizing nano-structures, and prevents a degradation of efficiency due to polarization by obtaining a non-polar active layer, thus improving droop characteristics.

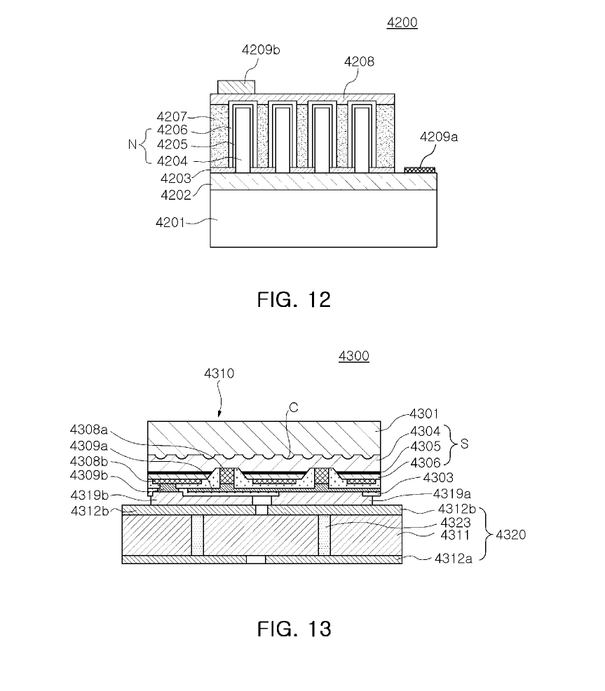

FIG. 12 is a cross-sectional view illustrating a nano-LED chip as another example of an LED chip that may be employed in a light source module.

As illustrated in FIG. 12, a nano-LED chip 4200 includes a plurality of nano-light emitting structures N formed on a substrate 4201. In this example, it is illustrated that the nano-light emitting structures N have a core-shell structure as a rod structure, but the present invention is not limited thereto and the nano-light emitting structures N may have a different structure such as a pyramid structure.

The nano-LED chip 4200 includes a base layer 4202 formed on the substrate 4201. The base layer 4202 is a layer providing a growth surface for the nano-light emitting structure, which may be a first conductivity-type semiconductor layer. A mask layer 4203 having an open area for the growth of the nano-light emitting structures N (in particular, the core) may be formed on the base layer 4202. The mask layer 4203 may be made of a dielectric material such as SiO₂ or SiNx.

In the nano-light emitting structures N, a first conductivity-type nano-core 4204 is formed by selectively growing a first conductivity-type semiconductor by using the mask layer 4203 having an open area, and an active layer 4205 and a second conductivity-type semiconductor layer 42064206 are formed as shell layers on a surface of the nano core 4204. Accordingly, the nano-light emitting structures N may have a core-shell structure in which the first conductivity-type semiconductor is the nano core and the active layer 4205 and the second conductivity-type semiconductor layer 42064206 enclosing the nano core are shell layers.

In an embodiment, nano-LED chip 4200 according to the present example includes a filler material 4207 filling spaces between the nano-light emitting structures N. The filler material 4207 may structurally stabilize the nano-light emitting structures N and may be employed as necessary in order to optically improve the nano-light emitting structures N. The filler material 4207 may be made of a transparent material such as SiO₂, or the like, but the present invention is not limited thereto. An ohmic-contact layer 4208 may be formed on the nano-light emitting structures and connected to the second conductivity-type semiconductor layer 42064206. The nano-LED chip 4200 includes first and second electrodes 4209a and 4209b connected to the base layer 4202 formed of the first conductivity-type semiconductor and the ohmic-contact layer 4208, respectively.

By forming the nano-light emitting structures such that they have different diameters, components, and doping densities, light having two or more different wavelengths may be emitted from the single device. By appropriately adjusting light having different wavelengths, white light may be implemented without using phosphors in the single device, and light having various desired colors or white light having different color temperatures may be implemented by combining a different LED chip with the foregoing device or combining wavelength conversion materials such as phosphors.

### Light Emitting Device

### Fourth Example

FIG. 13 illustrates a semiconductor light emitting device 2300 having an LED chip 4310 mounted on a mounting substrate 4320 as a light source that may be employed in the foregoing lighting device.

In an embodiment, the semiconductor light emitting device 2300 illustrated in FIG. 13 includes an LED chip 4310 mounted on a mounting substrate 4320. The LED chip 4310 is presented as an LED chip different from that of the example described above.

In an embodiment, LED chip 4310 includes a light emitting laminate S disposed in one surface of the substrate 4301 and first and second electrodes 4308a and 4308b disposed on the opposite side of the substrate 4301 based on the light emitting laminate S. Also, the LED chip 4310 includes an insulating part 4303 covering the first and second electrodes 4308a and 4308b.

The first and second electrodes 4308a and 4308b may include first and second electrode pads 4319a and 4319b connected thereto by electrical connection parts 4309a and 4309b.

The light emitting laminate S may include a first conductivity-type semiconductor layer 4304, an active layer 4305, and a second conductivity-type semiconductor layer 4306. The first electrode 4308a may be provided as a conductive via connected to the first conductivity-type semiconductor layer 4304 through the second conductivity-type semiconductor layer 4306 and the active layer 4305. The second electrode 4308b may be connected to the second conductivity-type semiconductor layer 4306.

A plurality of conductive vias may be formed in a single light emitting device region. The amount of vias and contact areas thereof may be adjusted such that the area the plurality of vias occupy on the plane of the regions in which they are in contact with the first conductivity-type semiconductor layer 4104 ranges from 1% to 5% of the area of the light emitting device region. A radius of the via on the plane of the regions in which the vias are in contact with the first conductivity-type semiconductor layer 4304 may range, for example, from 5 μm to 50 μm, and the number of vias may be 1 to 50 per light emitting device region according to a width of the light emitting device region. Although different according to a width of the light emitting device region, three or more vias may be provided. A distance between the vias may range from 100 μm to 500 μm, and the vias may have a matrix structure including rows and columns. Preferably, the distance between the vias may range from 150 μm to 450 μm. If the distance between the vias is smaller than 100 μm, the amount of vias is increased to relatively reduce a light emitting area to lower luminous efficiency, and if the distance between the vias is greater than 500 μm, current spreading may suffer to degrade luminous efficiency. A depth of the vias may range from 0.5 μm to 5.0 μm, although the depth of the vias may vary according to a thickness of the second conductivity-type semiconductor layer and the active layer.

In an embodiment, first and second electrodes 4308a and 4308b are formed by depositing a conductive ohmic material on the light emitting laminate S. The first and second electrodes 4308a and 4308b may include at least one of silver (Ag), aluminum (Al), nickel (Ni), chromium (Cr), copper (Cu), gold (Au), palladium (Pd), platinium (Pt), tin (Sn), titanium (Ti), tungsten (W), rhodium (Rh), iridium (Ir), ruthenium (Ru), magnesium (Mg), zinc (Zn), and an alloy material thereof. For example, the second electrode 4308b may be an ohmic electrode of a silver (Ag) layer laminated on the basis of the second conductivity-type semiconductor layer 4306. The Ag ohmic electrode may serve as a reflective layer of light. A single layer of nickel (Ni), titanium (Ti), platinum (Pt), tungsten (W), or an alloy layer thereof may be alternatively laminated on the Ag layer. In detail, an Ni/Ti layer, a TiW/Pt layer, or a Ti/W layer may be laminated on an Ag layer, or these layers may be alternately laminated on the Ag layer.

As the first electrode 4308a, on the basis of the first conductivity-type semiconductor layer 4304, a Cr layer may be laminated and Au/Pt/Ti layers may be sequentially laminated on the Cr layer, or on the basis of the second conductivity-type semiconductor layer 4306, an Al layer is laminated and Ti/Ni/Au layers may be sequentially laminated on the Al layer. The first and second electrodes 4308a and 4308b may be made of various other materials or may have various other lamination structures in order to enhance ohmic characteristics or reflecting characteristics.

In an embodiment, insulating part 4303 may have an open area exposing at least portions of the first and second electrodes 4308a and 4308b, and the first and second electrode pads 4319a and 4319b may be connected to the first and second electrodes 4308a and 4308b. The insulating part 4303 may be deposited to have a thickness ranging from 0.01 μm to 3 μm at a temperature equal to or lower than 500° C. through an SIO₂ and/or SiN CVD process.

The first and second electrodes 4308a and 4308b may be disposed in the same direction and may be mounted as a so-called flip-chip on a lead frame, or the like, as described hereinafter.

In particular, the first electrode 4308a may be connected to the first electrical connection part 4309a having a conductive via connected to the first conductivity-type semiconductor layer 4304 by passing through the second conductivity-type semiconductor layer 4306 and the active layer 4305 within the light emitting laminate S.

The amount, a shape, a pitch, a contact area with the first conductivity-type semiconductor layer 4304, and the like, of the conductive via and the first electrical connection part 4309a may be appropriately regulated in order to lower contact resistance, and the conductive via and the first electrical connection part 4309a may be arranged in a row and in a column to improve current flow.

Another electrode structure may include the second electrode 4308b directly formed on the second conductivity-type semiconductor layer 4306 and the second electrical connection portion 4309b formed on the second electrode 4308b. In addition to having a function of forming electrical-ohmic connection with the second conductivity-type semiconductor layer 4306, the second electrode 4308b may be made of a light reflective material, whereby, as illustrated in FIG. 13, in a state in which the LED chip 4310 is mounted as a so-called flip chip structure, light emitted from the active layer 4305 can be effectively emitted in a direction of the substrate 4301. Of course, the second electrode 4308b may be made of a light-transmissive conductive material such as a transparent conductive oxide, according to a main light emitting direction.

In an embodiment, two electrode structures as described above may be electrically separated by the insulating part 4303. The insulating part 4303 may be made of any material as long as it has electrically insulating properties. Namely, the insulating part 4303 may be made of any material having electrically insulating properties, and here, preferably, a material having a low degree of light absorption is used. For example, a silicon oxide or a silicon nitride such as SiO₂, SiOₓN_{y}, SiₓN_{y}, or the like, may be used. If necessary, a light reflective filler may be dispersed within the light-transmissive material to form a light reflective structure.

The first and second electrode pads 4319a and 4319b may be connected to the first and second electrical connection parts 4309a and 4309b to serve as external terminals of the LED chip 4310, respectively. For example, the first and second electrode pads 4319a and 4319b may be made of gold (Au), silver (Ag), aluminum (Al), titanium (Ti), tungsten (W), copper (Cu), tin (Sn), nickel (Ni), platinum (Pt), chromium (Cr), NiSn, TiW, AuSn, or a eutectic metal thereof. In this case, when the LED chip is mounted on the mounting substrate 3320, the first and second electrode pads 4319a and 4319b may be bonded by using the eutectic metal, so solder bumps generally required for flip chip bonding may not be used. The use of a eutectic metal advantageously obtains superior heat dissipation effects in the mounting method in comparison to the case of using solder bumps. In this case, in order to obtain excellent heat dissipation effects, the first and second electrode pads 4319a and 4319b may be formed to occupy a relatively large area.

The substrate 4301 and the light emitting laminate S may be understood with reference to content described above with reference to FIG. 10, unless otherwise described. Also, although not shown, a buffer layer may be formed between the light emitting structure S and the substrate 4301. The buffer layer may be employed as an undoped semiconductor layer made of a nitride, or the like, to alleviate lattice defects of the light emitting structure grown thereon.

In an embodiment, substrate 4301 may have first and second main surfaces opposing one another, and an uneven structure (i.e., a depression and protrusion pattern) may be formed on at least one of the first and second main surfaces. The uneven structure formed on one surface of the substrate 4301 may be formed by etching a portion of the substrate 4301 so as to be made of the same material as that of the substrate 4301. Alternatively, the uneven structure may be made of a heterogeneous material different from that of the substrate 4301.

In the present embodiment, since the uneven structure is formed on the interface between the substrate 4301 and the first conductivity-type semiconductor layer 4304, paths of light emitted from the active layer 4305 can be of diversity, and thus, a light absorption ratio of light absorbed within the semiconductor layer can be reduced and a light scattering ratio can be increased, increasing light extraction efficiency.

In detail, the uneven structure may be formed to have a regular or irregular shape. The heterogeneous material used to form the uneven structure may be a transparent conductor, a transparent insulator, or a material having excellent reflectivity. Here, as the transparent insulator, a material such as SiO₂, SiNₓ, Al₂O₃, HfO, TiO₂, or ZrO may be used. As the transparent conductor, a transparent conductive oxide (TCO) such as ZnO, an indium oxide containing an additive (e.g., Mg, Ag, Zn, Sc, Hf, Zr, Te, Se, Ta, W, Nb, Cu, Si, Ni, Co, Mo, Cr, Sn), or the like, may be used. As the reflective material, silver (Ag), aluminum (Al), or a distributed Bragg reflector (DBR) including multiple layers having different refractive indices, may be used. However, the present invention is not limited thereto.

In an embodiment, substrate 4301 may be removed from the first conductivity-type semiconductor layer 4304. To remove the substrate 4301, a laser lift-off (LLO) process using a laser, an etching or a polishing process may be used. Also, after the substrate 4301 is removed, depressions and protrusions may be formed on the surface of the first conductivity-type semiconductor layer 1304.

As illustrated in FIG. 13, the LED chip 4310 is mounted on the mounting substrate 4320. The mounting substrate 4320 includes upper and lower electrode layers 4312b4312b and 4312a formed on upper and lower surfaces of the substrate body 4311, and vias 4313 penetrating through the substrate body 4311 to connect the upper and lower electrode layers 4312b4312b and 4312a. The substrate body 4311 may be made of a resin, a ceramic, or a metal, and the upper or lower electrode layer 4312b4312b or 4312a may be a metal layer made of gold (Au), copper (Cu), silver (Ag), or aluminum (Al).

Of course, the substrate on which the foregoing LED chip 4310 is mounted is not limited to the configuration of the mounting substrate 4320 illustrated in FIG. 13, and any substrate having a wiring structure for driving the LED chip 4310 may be employed. For example, any one of the substrates described above with reference to FIGS. 3 through 9 may be employed, or a package structure in which an LED chip is mounted on a package body having a pair of lead frames may be provided.

Other Examples of Light Emitting Devices

LED chips having various structures other than that of the foregoing LED chip described above may also be used. For example, an LED chip in which surface-plasmon polaritons (SPP) are formed in a metal-dielectric boundary of an LED chip to interact with quantum well excitons, thus obtaining significantly improved light extraction efficiency, may also be advantageously used.

In an embodiment, the light emitting element 400 may be configured to include at least one of a light emitting device emitting white light by combining yellow, green, red, and orange phosphors with a blue LED chip and a purple, blue, green, red, and infrared light emitting device. In this case, the light emitting element 400 may control a color rendering index (CRI) to range from a sodium-vapor (Na) lamp (40) to a sunlight level (100), or the like, and control a color temperature ranging from 2,000K to 20,000K level to generate various levels of white light. If necessary, the light emitting element 400 may generate visible light having purple, blue, green, red, orange colors, or infrared light to adjust an illumination color according to a surrounding atmosphere or mood. Also, the light emitting device may generate light having a special wavelength stimulating plant growth.

White light generated by combining yellow, green, red phosphors to a blue LED and/or combining at least one of a green LED and a red LED thereto may have two or more peak wavelengths and may be positioned in a segment linking (x, y) coordinates (0.4476, 0.4074), (0.3484, 0.3516), (0.3101, 0.3162), (0.3128, 0.3292), (0.3333, 0.3333) of a CIE 1931 chromaticity diagram. Alternatively, white light may be positioned in a region surrounded by a spectrum of black body radiation and the segment. A color temperature of white light corresponds to a range from about 2,000K to about 20,000K.

Phosphors may have the following empirical formula and colors.

Oxide-based phosphors: Yellow and green Y3Al5O12:Ce, Tb3Al5O12:Ce, Lu3Al5O12:Ce

Silicate-based phosphors: Yellow and green (Ba,Sr)2SiO4:Eu, yellow and orange (Ba,Sr)3SiO5:Ce

Nitride-baed phosphors: Green β-SiAlON:Eu, yellow L3Si6O11:Ce, orange α-SiAlON:Eu, red CaAlSiN3:Eu, Sr2Si5N8:Eu, SrSiAl4N7:Eu

Fluoride-based phosphors: KSF-based red K2SiF6:Mn4+

Phosphor compositions should be basically conformed with Stoichiometry, and respective elements may be substituted with different elements of respective groups of the periodic table. For example, strontium (Sr) may be substituted with barium (Ba), calcium (Ca), magnesium (Mg), or the like, of alkali earths, and yttrium (Y) may be substituted with terbium (Tb), Lutetium (Lu), scandium (Sc), gadolinium (Gd), or the like. Also, europium (Eu), an activator, may be substituted with cerium (Ce), terbium (Tb), praseodymium (Pr), erbium (Er), ytterbium (Yb), or the like, according to a desired energy level, and an activator may be applied alone, or a coactivator, or the like, may be additionally applied to change characteristics.

Also, materials such as quantum dots, or the like, may be applied as materials that replace phosphors, and phosphors and quantum dots may be used in combination or alone in an LED.

A quantum dot may have a structure including a core (3 nm to 10 nm) such as CdSe, InP, or the like, a shell (0.5 nm to 2 nm) such as ZnS, ZnSe, or the like, and a ligand for stabilizing the core and the shell, and may implement various colors according to sizes.

Table 1 below shows types of phosphors in applications fields of white light emitting devices using a blue LED (wavelength: 440 nm to 460 nm).

TABLE 1

| Purpose | Phosphors |
|---|---|
| LED TV BLU | β-SiAlON:Eu2+ |
| | (Ca, Sr)AlSiN3:Eu2+ |
| | L3Si6O11:Ce3+ |
| | K2SiF6:Mn4+ |
| Lighting Devices | Lu3Al5O12:Ce3+ |
| | Ca-α-SiAlON:Eu2+ |
| | L3Si6N11:Ce3+ |
| | (Ca, Sr)AlSiN3:Eu2+ |
| | Y3Al5O12:Ce3+ |
| | K2SiF6:Mn4+ |
| Side Viewing | Lu3Al5O12:Ce3+ |
| (Mobile, Notebook PC) | Ca-α-SiAlON:Eu2+ |
| | L3Si6N11:Ce3+ |
| | (Ca, Sr)AlSiN3:Eu2+ |
| | Y3Al5O12:Ce3+ |
| | (Sr, Ba, Ca, Mg)2SiO4:Eu2+ |
| | K2SiF6:Mn4+ |
| Electrical Components | Lu3Al5O12:Ce3+ |
| (Vehicle Head Lamp, etc.) | Ca-α-SiAlON:Eu2+ |
| | L3Si6N11:Ce3+ |
| | (Ca, Sr)AlSiN3:Eu2+ |
| | Y3Al5O12:Ce3+ |
| | K2SiF6:Mn4+ |

Phosphors or quantum dots may be applied by using at least one of a method of spraying them on a light emitting device, a method of covering as a film, and a method of attaching as a sheet of ceramic phosphor, or the like.

As the spraying method, dispensing, spray coating, or the like, is generally used, and dispensing includes a pneumatic method and a mechanical method such as a screw fastening scheme, a linear type fastening scheme, or the like. Through a jetting method, an amount of dotting may be controlled through a very small amount of discharging and color coordinates (or chromaticity) may also be controlled. In the case of a method of collectively applying phosphors on a wafer level or on a mounting board on which an LED is mounted, productivity can be enhanced and a thickness can be easily controlled.

The method of directly covering a light emitting device with phosphors or quantum dots as a film may include electrophoresis, screen printing, or a phosphor molding method, and these methods may have a difference according to whether a lateral surface of a chip is required to be coated or not.

In an embodiment, in order to control efficiency of a long wavelength light emitting phosphor re-absorbing light emitted in a short wavelength, among two types of phosphors having different light emitting wavelengths, two types of phosphor layer having different light emitting wavelengths may be provided, and in order to minimize re-absorption and interference of chips and two or more wavelengths, a DBR (ODR) layer may be included between respective layers. In order to form a uniformly coated film, a phosphor is fabricated as a film or a ceramic form and attached to a chip or a light emitting device.

In order to differentiate light efficiency and light distribution characteristics, a light conversion material may be positioned in a remote form, and in this case, the light conversion material may be positioned together with a material such as a light-transmissive polymer, glass, or the like, according to durability and heat resistance.

A phosphor applying technique plays the most important role in determining light characteristics in an LED device, so techniques of controlling a thickness of a phosphor application layer, a uniform phosphor distribution, and the like, have been variously researched.

A quantum dot (QD) may also be positioned in a light emitting device in the same manner as that of a phosphor, and may be positioned in glass or a light-transmissive polymer material to perform optical conversion.

In an embodiment, in order to protect a light emitting device from an external environment or in order to improve light extraction efficiency of light emitted to the outside of a light emitting device, a light-transmissive material may be positioned on the light emitting device as a filler. In this case, a transparent organic solvent such as epoxy, silicon, a hybrid of epoxy and silicon, or the like, is applied as a light-transmissive material, and the light-transmissive material may be cured according to heating, light irradiation, a time-lapse method, or the like.

In the case of silicon, polydimethyl siloxane is classified as a methyl-based silicon and polymethylphenyl siloxane is classified as a phenyl-based silicon. The methyl-based silicon and the phenyl-based silicon have differences in refractive indexes, water vapor transmission rates, light transmittance amounts, light fastness qualities, and thermostability. Also, the methyl-based silicon and the phenyl-based silicon have differences in curing speeds according to a cross linker and a catalyst, affecting phosphor distribution.

Light extraction efficiency varies according to a refractive index of a filler, and in order to minimize a gap between a refractive index of the outermost medium of a chip in a portion from which blue light is emitted and a refractive index of a portion emitted to air, two or more types of silicon having different refractive indices may be sequentially laminated.

In general, the methyl-based silicon has the highest level of thermostability, and variations in a temperature increase are reduced in order of phenyl-based silicon, hybrid silicon, and epoxy silicon. Silicon may be classified as a gel-type silicon, an elastomer-type silicon, and a resin-type silicon according to the degree of hardness of the resin-type silicon.

The light emitting device may further include an optical element for radially guiding light irradiated from the light emitting device. In this case, a previously formed optical element may be attached to a light emitting device, or a fluidic organic solvent may be injected into a mold with a light emitting device mounted therein and solidified.

The optical element attachment method includes directly attaching an optical element to a filler, bonding only an upper portion of a chip or an outer portion of a light emitting device or an outer portion of the optical element, spaced apart from the filler, and the like. As the method of injecting into a mold, injection molding, transfer molding, compression molding, or the like, may be used. Light distribution characteristics may be changed according to lens shapes (concave, convex, uneven, conical, and geometrical structures), and the optical element may be modified according to efficiency and light distribution characteristics.

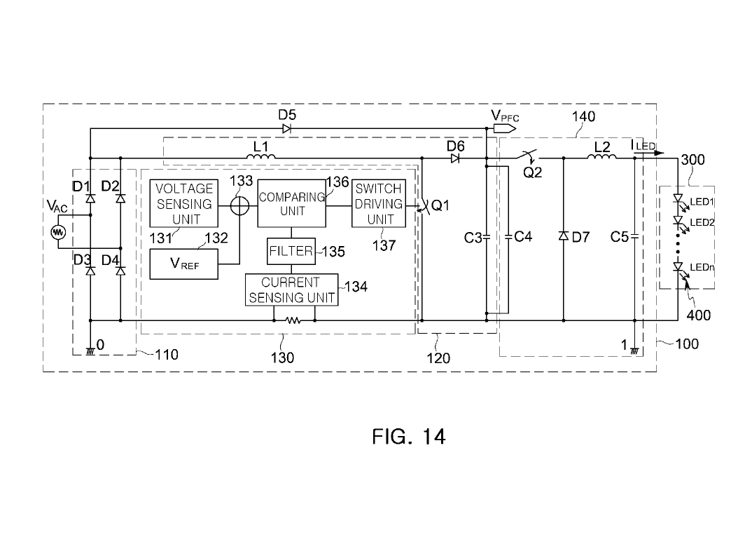

Hereinafter, circuit configurations and operations of an LED driving device and a lighting device according to exemplary embodiments of the present disclosure will be descried with reference to FIGS. 14 through 18.

FIGS. 14 through 16 are circuit diagrams of a lighting device according to an exemplary embodiment of the present disclosure.

Referring to FIG. 14, the LED driving device 100 according to an exemplary embodiment of the present disclosure may include the rectifying unit 110 converting an AC signal V_{AC} output by the transformer 200 into a DC signal, the PFC converter 120, the controller 130 controlling an operation of a switching element Q1 included in the PFC converter 120, and the DC-DC converter 140. The light emitting unit 300 including a plurality of light emitting elements 400 may be connected to an output terminal of the DC-DC converter 140.

The rectifying unit 110 may include a diode bridge, and the DC signal output by the rectifying unit 110 may be delivered to the PFC converter 120 including an inductor L1, a diode D6, a capacitor C3, and the switching element Q1. The PFC converter 120 outputs a DC voltage V_{PFC}. The output voltage V_{PFC} from the PFC converter 120 may be detected by the controller 130 and used to control an operation of the switching element Q1.

In an embodiment, the controller 130 controlling an operation of the switching element Q1 may include a voltage sensing unit 131 detecting the output voltage V_{PFC} from the PFC converter 120, a reference voltage generating unit 132 generating a predetermined reference voltage V_{REF}, an adding circuit 133, and the like. The controller 130 may further include a current sensing unit 134 detecting a current I_{LED} flowing in the plurality of light emitting elements 400 included in the light emitting unit 300, a filter 135, a comparing unit 136, a switch driving unit 137, and the like.

In an embodiment, the voltage sensing unit 131 may detect the output voltage V_{PFC} from the PFC converter 120 and deliver the same to the adding circuit 133. The adding circuit 133 adds the output voltage V_{PFC} from the PFC converter 120 and the reference voltage V_{REF} to generate a reference voltage of the comparing unit 136. For example, the comparing unit 136 may include an operational amplifier, and a signal output from the adding circuit 133 may be input to a non-inverting terminal of the operational amplifier and compared with a signal input to an inverting terminal of the operational amplifier.

In the case in which the comparing unit 136 includes an operational amplifier, a signal detected by the current sensing unit 134 may be input to an inverting terminal of the operational amplifier. The current sensing unit 134 detects the current I_{LED} flowing in the plurality of light emitting elements 400 included in the light emitting unit 300 and converts the detected current I_{LED} into a voltage signal. The voltage signal generated by the current sensing unit 134 passes through a filter 135 and is input to the comparing unit 136. The comparing unit 136 may compare the signal detected by the current sensing unit 134 with an output signal from the adding circuit 133, and adjust at least one of a switching frequency and a duty ratio of the switching element Q1 on the basis of the comparison results.

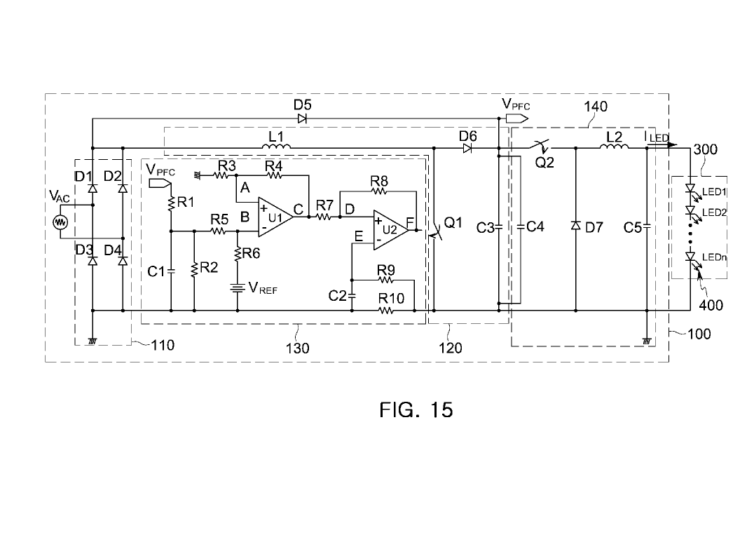

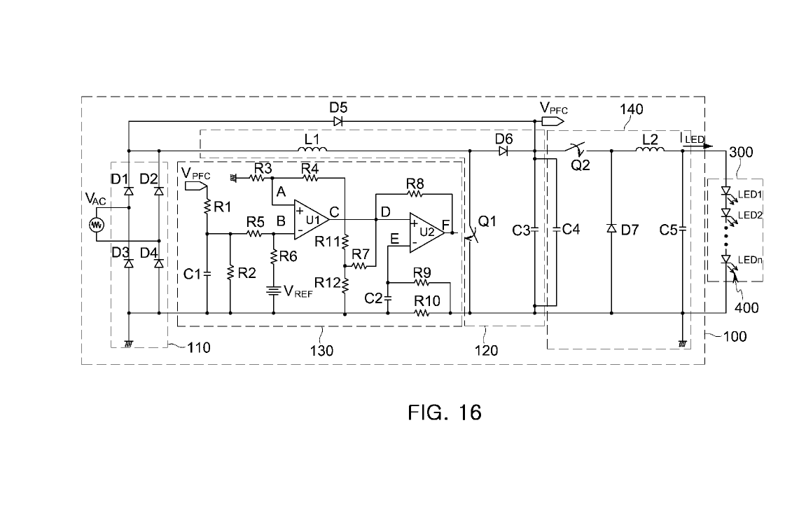

Hereinafter, an operation of the LED driving device according to an exemplary embodiment of the present disclosure will be described in more detail with reference to FIGS. 15 and 16.

Referring to FIG. 15, the LED driving device 100 may include the rectifying unit 110 converting the AC signal V_{AC} output by the transformer 200 into a DC signal, the PFC converter 120 connected to an output terminal of the rectifying unit 110, the controller 130 controlling an operation of the PFC converter 120, the DC-DC converter 140, and the like. The DC-DC converter 140 may include a boost converter, a buck converter, or the like, converting a level of the DC voltage, and the plurality of light emitting elements 400 included in the light emitting unit 300 are turned on by an output from the DC-DC converter 140. The rectifying unit 110 may include diode bridges D1 to D4 for converting the AC signal into the DC signal.

The PFC converter 120 may include the inductor L1, the capacitor C3, the diode D6, and the switching element Q1. The PFC converter 120 may be connected to an output terminal of the rectifying unit 110, and input impedance of the LED driving device 100 may be determined based on operational characteristics of the PFC converter 120. In order to operate the light emitting unit 300 with uniform brightness regardless of a change in an output from the transformer 200 supplying an AC signal to the LED driving device 100, impedance matching between the output terminal of the transformer 200 and the input terminal of the LED driving device 100 is required. Here, impedance matching may be achieved by adjusting input impedance of the LED driving device 100 by controlling operational characteristics of the PFC converter 120.

The operational characteristics of the PFC converter 120 may be determined by an operation of the switching element Q1, excluding the passive elements inductor L1, capacitor C3, and diode D6. Namely, operational characteristics of the PFC converter 120 may be determined by adjusting a switching frequency, a duty ratio, or the like, of the switching element Q1. The switching frequency or the duty ratio of the switching element Q1 may be determined by a signal output by an operational amplifier U2 of the controller 130.

The controller 130 may detect the output voltage V_{PFC} from the PFC converter 120. An operational amplifier U1 may add the detected voltage V_{PEC} with the predetermined reference voltage V_{REF}, and outputs the result. The output from the operational amplifier U1 may be applied to a non-inverting terminal of the operational amplifier U2. A capacitor C2 and resistors R9 and R10 connected to an inverting terminal of the operational amplifier U2 can operate as a current sensing unit 134 detecting a current I_{LED} flowing in the plurality of light emitting elements 400. The current sensing unit 134 may convert the current flowing in the plurality of light emitting elements 400 into a voltage to generate a detection signal, and deliver the generated detection signal to the inverting terminal of the operational amplifier U2.

In an embodiment, the operational amplifier U2 can operate as a Schmitt Trigger circuit, and compare the signal input to the inverting terminal thereto with an upper trigger point (UTP) and a lower trigger point (LTP). Here, the UTP or the LTP may be changed by a ripple component included in the PFC converter 120 or the output voltage V_{PFC} from the PFC converter 120. The operational amplifier U2 may compare the results obtained by detecting the current I_{LED} flowing in the plurality of light emitting elements 400 with a reference signal reflecting the ripple component included in the PFC converter 120 and generate a high or low level output signal.

As a result, operational characteristics of the switching element Q1 may be determined by the level of the current flowing in the plurality of light emitting elements 400, the output voltage V_{PFC} from the PFC converter 120, and the ripple component included in the output voltage V_{PFC}. In this case, since the ripple component included in the output voltage V_{PFC} from the PFC converter 120 can be determined by results of impedance matching between the output terminal of the transformer 200 and the input terminal of the LED driving device 100, an operation of the switching element Q1 may be controlled to optimize impedance matching between the output terminal of the transformer 200 and the input terminal of the LED driving device 100.

In an embodiment, a diode D5 may be connected between the output terminal of the PFC converter 120 and the output terminal of the rectifying unit 110. The diode D5 may be used to ensure a smooth operation of the light emitting unit 300 in case of a start-up. For example, in an initial stage in which the AC signal V_{AC} is generated by the transformer 200 and delivered to the rectifying unit 110, a designated time may be required for the switching element Q1 to operate. Here, a DC signal generated by the rectifying unit 110 may be delivered directly to the DC-DC converter 140 through the diode D5, ensuring a smooth operation of the light emitting unit 300 in the initial driving conditions.

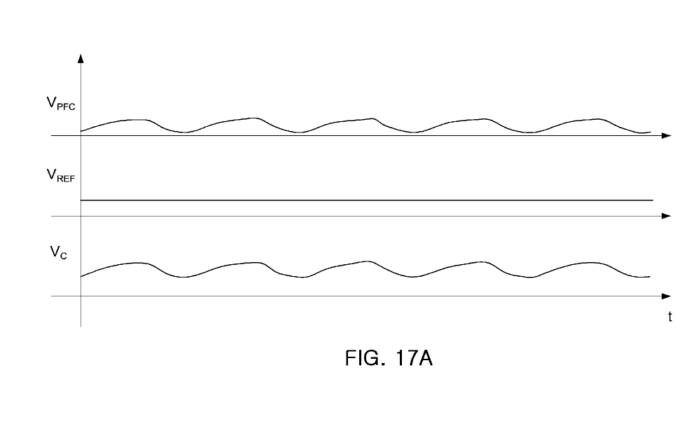

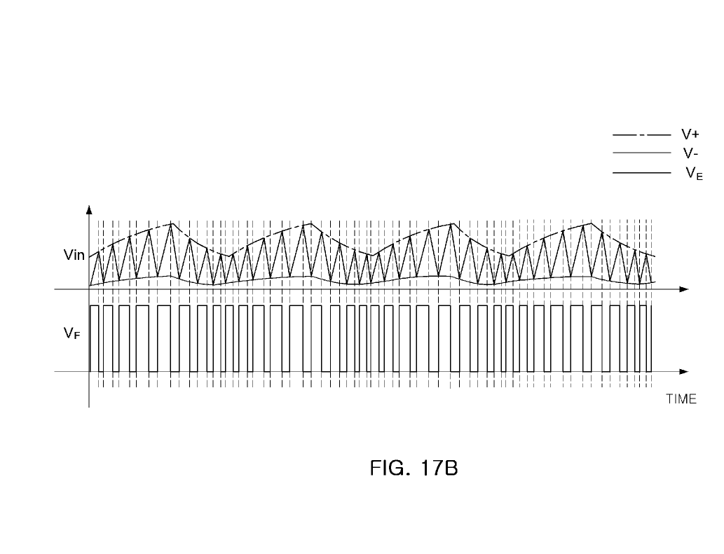

FIG. 16 illustrates a circuit configuration in which a variable range of a switching frequency of the PFC converter 120 is reduced by connecting a distribution resistor to the adding circuit 133 including the operational amplifier U1. An operation of the circuit illustrated in FIG. 16 may be similar to that of the circuit illustrated in FIG. 15. Hereinafter, operations of the circuits illustrated in FIGS. 14 through 16 will be described with reference to graphs of FIGS. 17A and 17B. For description purposes, the circuit illustrated in FIG. 16 will be described as an example with reference to the graphs of FIGS. 17A and 17B.

As described above in the embodiments of FIGS. 14 and 15, the controller 130 may include the voltage sensing unit 131, the reference voltage generating unit 132, the adding circuit 133, the current sensing unit 134, the filter 135, the comparing unit 136, and the switch driving unit 137. Referring to FIG. 16, the output voltage V_{PFC} from the PFC converter 120 and the reference voltage V_{REF} may be added by the operational amplifier U1, included in the adding circuit 133, and delivered to the non-inverting terminal of the operational amplifier U2. Distribution resistors R11 and R12 can be connected to an output terminal C of the operational amplifier U1, whereby a variable range of a switching frequency of the output voltage V_{PFC} from the PFC converter 120 can be reduced.

FIG. 17A is a graph showing the output voltage V_{PFC} from the PFC converter 120, the reference voltage V_{REF}, and an output voltage V_{C} from the operational amplifier U1. The reference voltage V_{REF} may be provided as a constant voltage, and the output voltage V_{PFC} from the PFC converter 120 may be a DC voltage having a predetermined level and including a ripple component. The operational amplifier U1 can operate as the adding circuit 133, so the output voltage Vc from the operational amplifier U1 may appear as the sum of the output voltage V_{PFC} and the reference voltage V_{REF}.

FIG. 17B is a graph showing input/output signals from the operational amplifier U2 operating as a Schmitt Trigger circuit. In the graph of FIG. 17B, referring to Vin representing an input signal of the operational amplifier U2, V+ and V− correspond to a UTP and an LTP of the Schmitt Trigger circuit, respectively. In the Schmitt Trigger circuit including the operational amplifier U2, the UTP V+ and the LTP V− may be determined according to a saturation state of an output terminal of the operational amplifier U2. In the present exemplary embodiment, the output terminal F and a non-inverting terminal D of the operational amplifier U2 can be connected, so the UTP V+ and the LTP V− of the Schmitt Trigger circuit may be altered according to a signal applied to the non-inverting terminal D of the operational amplifier U2, such as an output signal from the operational amplifier U1 and a saturation state of the output terminal of the operational amplifier U2.

An output signal V_{F} from the operational amplifier U2 operating as a Schmitt Trigger circuit may be determined by a voltage V_{E} input to the inverting terminal of the operational amplifier U2. The voltage V_{E} may be a voltage generated by detecting a current flowing in the plurality of light emitting elements 400 included in the light emitting unit 300. When the voltage V_{E} is reduced to the LTP V−, the output voltage V_{F} from the operational amplifier U2 is changed from the low level to a high level. Conversely, when the voltage V_{E} is increased to the UTP V+, the output voltage V_{F} from the operational amplifier U2 is changed from the high level to a low level. FIG. 17B shows the input/output relationship of the operational amplifier U2.

When the voltage V_{F} is at a high level, the switching element Q1 is turned on, and when the voltage V_{F} is at a low level, the switching element Q1 is turned off. Since the voltage V_{F} is determined by the voltage V_{E} generated from the current flowing in the plurality of light emitting elements 400, the ripple component included in the output voltage V_{PFC} from the PFC converter 120, and the like, the operational characteristics of the switching element Q1 are controlled by the ripple component included in the output voltage from the PFC converter 120 and the current flowing in the plurality of light emitting elements 400. Since the ripple component included in the output voltage V_{PFC} from the PFC converter 120 can be determined by impedance matching between the output terminal of the transformer 200 and the input terminal of the LED driving device 100, the operational characteristics of the switching element Q1 may be controlled by the current flowing in the plurality of light emitting elements 400 and impedance matching between the LED driving device 100 and the transformer 200.

In a case in which a duty ratio of the switching element Q1 is increased, such as when a turned-on duration of the switching element Q1 is increased, input impedance of the PFC converter 120 may be reduced. Conversely, when the duty ratio of the switching element Q1 is reduced, input impedance of the PFC converter 120 may be increased. Thus, in a case in which the output voltage V_{PFC} from the PFC converter 120 is increased, such as when an output from the transformer 200 is increased, the duty ratio of the switching element Q1 may be increased to reduce input impedance of the PFC converter 120, thus driving the light emitting elements 400 to have the desired luminance. Conversely, when the output from the transformer 200 is reduced to reduce the voltage V_{PFC}, the duty ratio of the switching element Q1 may be reduced to increase input impedance of the PFC converter 120.

In an embodiment, when the output voltage V_{PFC} from the PFC converter 120 is increased or reduced, the UTP V+ of the operational amplifier U2 operating as a Schmitt Trigger circuit can be increased or reduced as well. When the output voltage V_{PFC} is increased to increase the voltage V+, a time required for the voltage V_{E} to reach the voltage V+ may be increased in the graph of FIG. 17B, lengthening a turn-on duration of the switching element Q1, which results in an increase in the duty ratio of the switching element Q1. Accordingly, input impedance of the PFC converter 120 may be reduced. In a reverse case, the voltage V+ is reduced to shorten the turn-on duration of the switching element Q1 to reduce the duty ratio of the switching element Q1, and thus, input impedance of the PFC converter 120 may be increased. In this manner, impedance matching between the input terminal of the LED driving device 100 and the output terminal of the transformer 200 may be adjusted.

In a state in which the LED driving device 100 and the transformer 200 are properly impedance-matched, the output voltage V_{PFC} from the PFC converter 120 may have a small amount of ripple component. As a result, in the present exemplary embodiment, since the UTP V+ and the LTP V− of the Schmitt Trigger circuit included in the controller 130 can be determined by impedance matching between the LED driving device 100 and the transformer 200, and an output from the transformer 200, the controller 130 may increase operational efficiency of the overall circuit and reduce a heating value of the overall circuit by adjusting impedance of the input terminal of the LED driving device 100.

Also, compatibility between the transformer 200 generally applied to a halogen lamp, or the like, and the LED driving device 100 for driving the plurality of light emitting elements 400 can be secured. The transformer 200 supplying a driving signal to a general halogen lamp may be included in a stabilizer and provided to lighting facilities, and the LED driving device 100 according to the present exemplary embodiment may be directly connected to the stabilizer or transformer already installed in the lighting facilities to drive the light emitting elements 400.

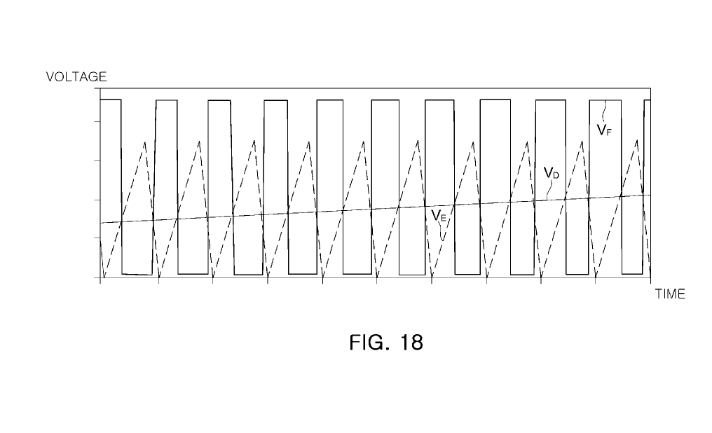

FIG. 18 is a graph showing relationships between the voltage V_{D} applied to the non-inverting terminal D of the operational amplifier U2, the voltage V_{E} applied to the inverter terminal E of the operational amplifier U2, and the output voltage V_{F} from the operational amplifier U2. Referring to FIG. 18, the voltage V_{D} applied to the non-inverting terminal D tends to be gradually increased with the passage of time. Thus, voltage V_{D} may correspond to a case in which the output voltage V_{PFC} from the PFC converter 120 is gradually increased. The voltage V_{E} applied to the inverting terminal E can have a triangular waveform. The output voltage V_{F} may have a high level when the voltage V_{D} is higher than the voltage V_{E}, and have a low level in the opposite case.

The voltage V_{E} applied to the inverting terminal E of the operational amplifier U2 may correspond to a voltage generated by detecting the current flowing in the light emitting elements 400. Since the voltage V_{E} may have a triangular waveform having a predetermined pattern, as the voltage V_{D} is gradually increased, a time section in which the voltage V_{E} is higher than V_{D} can be gradually reduced. This may correspond to a case in which the output from the PFC converter 120 is increased, more specifically to a case in which the output from the transformer 200 is increased. Referring to FIG. 18, as the output from the transformer 200 is increased, the time section in which the voltage V_{E} is higher than the voltage V_{D} may be gradually reduced, and thus, a duty ratio of the switching element Q1 is increased, reducing input impedance of the PFC converter 120. Thus, even in a case in which the output from the transformer 200 is changed, the light emitting elements 400 may be controlled to have the desired luminance.

In an embodiment, the LED driving device 100 or the lighting device 10 including the LED driving device 100 as described above may be applied to an indoor lighting device or an outdoor lighting device according to the purpose thereof. The indoor LED lighting device may include a lamp, a fluorescent lamp (LED-tube), a flat panel type lighting device replacing an existing lighting fixture (retrofit), and the outdoor LED lighting device may include a streetlight, a security light, a flood light, a scene lamp, a traffic light, and the like.

Also, the lighting device using LEDs may be utilized as an internal or external light source of a vehicle. As an internal light source, the lighting device using the LED may be used as an indoor light of a vehicle, a reading light, or as various dashboard light sources. As an external light source, the lighting device using the LED may be used as for a light source in vehicle lighting fixture such as a headlight, a brake light, a turn signal lamp, a fog light, a running light, and the like.

In addition, the LED lighting device may also be applicable as a light source used in robots or various mechanic facilities. In particular, LED lighting using light within a particular wavelength band may accelerate plant growth, and stabilize a user's mood or treat a disease using sensitivity (or emotional) illumination (or lighting).

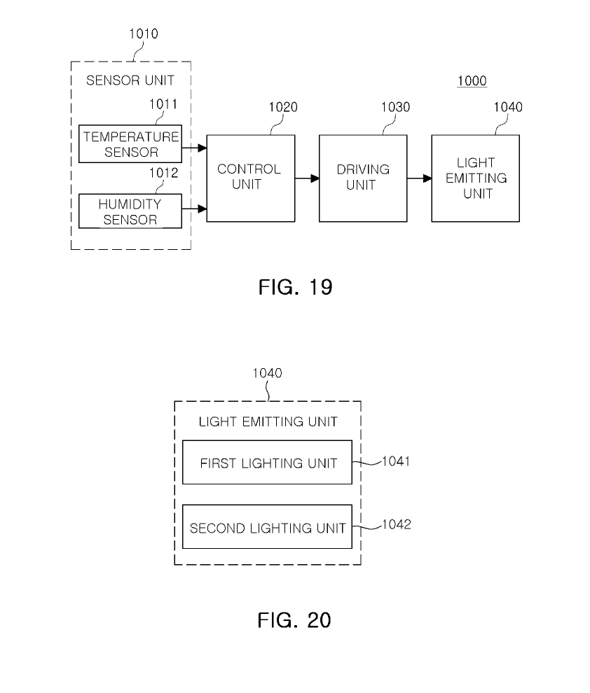

A lighting system employing the foregoing lighting device will be described with reference to FIGS. 19 through 22. The lighting system according to the present embodiment may automatically regulate a color temperature according to a surrounding environment (e.g., temperature and humidity) and provide a lighting device as sensitivity lighting meeting human sensitivity, rather than serving as simple lighting.

FIG. 19 is a block diagram schematically illustrating a lighting system according to an embodiment of the present disclosure.

Referring to FIG. 19, a lighting system 1000 according to an embodiment of the present disclosure may include a sensor unit 1010, a control unit 1020, a driving unit 1030, and a light emitting unit 1040.

The sensor unit 1010 may be installed in an indoor or outdoor area, and may have a temperature sensor 1011 and a humidity sensor 1012 to measure at least one air condition among an ambient temperature and humidity. The sensor unit 1010 delivers the measured air condition, i.e., the measured temperature and humidity, to the control unit 1020 electrically connected thereto.

The control unit 1020 may compare the measured air temperature and humidity with air conditions (temperature and humidity ranges) previously set by a user, and determines a color temperature of the light emitting unit 1040 corresponding to the air condition. To this end, the control unit 1020 may be electrically connected to the driving unit 1030, and control the light emitting unit 1040 to be driven at the determined color temperature.

The light emitting unit 1040 operates according to power supplied by the driving unit 1030. The light emitting unit 1040 may include at least one lighting device illustrated in FIGS. 20 to 22. For example, as illustrated in FIG. 20, the light emitting unit 1040 may include a first lighting device 1041 and a second lighting device 1042 having different color temperatures, and f the lighting devices 1041 and 1042 may include a plurality of light emitting devices emitting the same white light, respectively.

The first lighting device 1041 may emit white light having a first color temperature, and the second lighting device 1042 may emit white light having a second color temperature, and here, the first color temperature may be lower than the second color temperature. Conversely, the first color temperature may be higher than the second color temperature. Here, white color having a relatively low color temperature corresponds to a warm white color, and white color having a relatively high color temperature corresponds to a cold white color. When power is supplied to the first and second lighting devices 1041 and 1042, the first and second lighting devices 1041 and 1042 emit white light having first and second color temperatures, respectively, and the respective white light may be mixed to implement white light having a color temperature determined by the control unit 1020.

In detail, in a case in which the first color temperature is lower than the second color temperature, if the color temperature determined by the control unit 1020 is relatively high, an amount of light from the first lighting device 1041 may be reduced and an amount of light from the second lighting device 1042 may be increased to implement mixed white light having the determined color temperature. Conversely, when the determined color temperature is relatively low, an amount of light from the first lighting device 1041 may be increased and an amount of light from the second lighting device 1042 may be reduced to implement white light having the determined color temperature. Here, the amount of light from each of the lighting devices 1041 and 1042 may be implemented by differently regulating an amount of power supplied from the driving unit 1030 or may be implemented by regulating the number of driven light emitting devices.

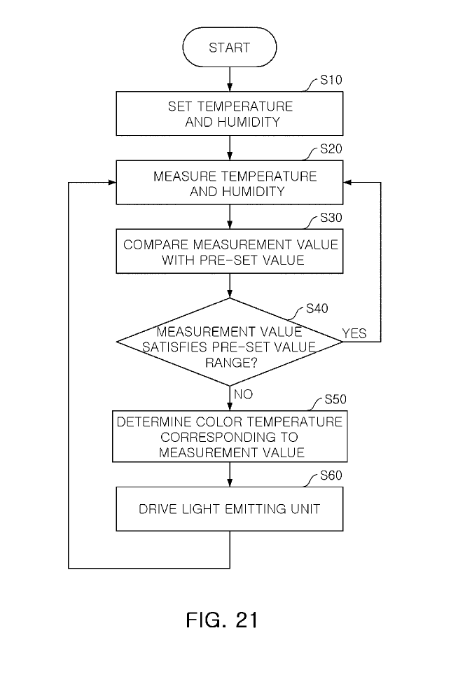

FIG. 21 is a flowchart illustrating a method for controlling the lighting system of FIG. 19. Referring to FIG. 21, first, the user sets a color temperature according to temperature and humidity ranges through the control unit 1020 (S10). The set temperature and humidity data are stored in the control unit 1020.

In general, when a color temperature is equal to or more than 6000K, a color providing a cool feeling, such as blue, may be produced, and when a color temperature is less than 4000K, a color providing a warm feeling, such as red, may be produced. Thus, in the present embodiment, when temperature and humidity exceed 20° C. and 60%, respectively, the user may set the light emitting unit 1040 to be turned on to have a color temperature higher than 6000K through the control unit 1020, when temperature and humidity range from 10° C. to 20° C. and 40% to 60%, respectively, the user may set the light emitting unit 1040 to be turned on to have a color temperature ranging from 4000K to 6000K through the control unit 1020, and when temperature and humidity are lower than 10° C. and 40%, respectively, the user may set the light emitting unit 1040 to be turned on to have a color temperature lower than 4000K through the control unit 1020.

Next, the sensor unit 1010 measures at least one of conditions among ambient temperature and humidity (S20). The temperature and humidity measured by the sensor unit 1010 are delivered to the control unit 1020.

Subsequently, the control unit 1020 compares the measurement values delivered from the sensor unit 1010 with pre-set values, respectively (S30). Here, the measurement values are temperature and humidity data measured by the sensor unit 1010, and the set values are temperature and humidity data which have been set by the user and stored in the control unit 1020 in advance. Namely, the control unit 1020 compares the measured temperature and humidity with the pre-set temperature and humidity.

According to the comparison results, the control unit 1020 determines whether the measurement values satisfy the pre-set ranges (S40). When the measurement values satisfy the pre-set values, the control unit 1020 maintains a current color temperature, and measures again temperature and humidity (S20). In an embodiment, when the measurement values do not satisfy the pre-set values, the control unit 1020 detects pre-set values corresponding to the measurement values, and determines a corresponding color temperature (S50). The control unit 1020 controls the driving unit 1030 to cause the light emitting unit 1040 to be driven at the determined color temperature.

Then, the driving unit 1030 drives the light emitting unit 1040 to have the determined color temperature (S60). That is, the driving unit 1030 supplies required power to drive the light emitting unit 1040 to implement the predetermined color temperature. Accordingly, the light emitting unit 1040 may be adjusted to have a color temperature corresponding to the temperature and humidity previously set by the user according to ambient temperature and humidity.

In this manner, the lighting system 1000A is able to automatically regulate a color temperature of the indoor lighting according to changes in ambient temperature and humidity, thereby satisfying human moods varied according to changes in the surrounding natural environment and providing psychological stability.

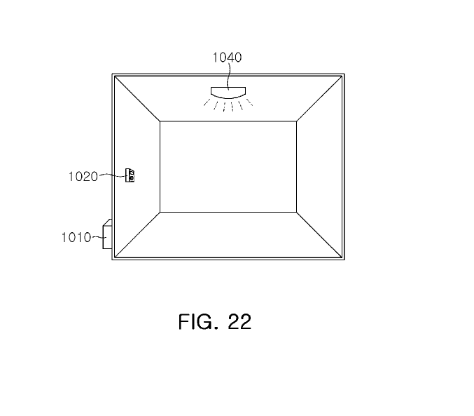

FIG. 22 is a view schematically illustrating the use of the lighting system of FIG. 19. As illustrated in FIG. 22, the light emitting unit 1040 may be installed on the ceiling as an indoor lamp. Here, the sensor unit 1010 may be may be implemented as a separate device and installed on an external wall in order to measure outdoor temperature and humidity. The control unit 1020 may be installed in an indoor area to allow the user to easily perform setting and ascertainment operations. The lighting system is not limited thereto, but may be installed on the wall in the place of an interior illumination device or may be applicable to a lamp, such as a desk lamp, or the like, that can be used in indoor and outdoor areas.

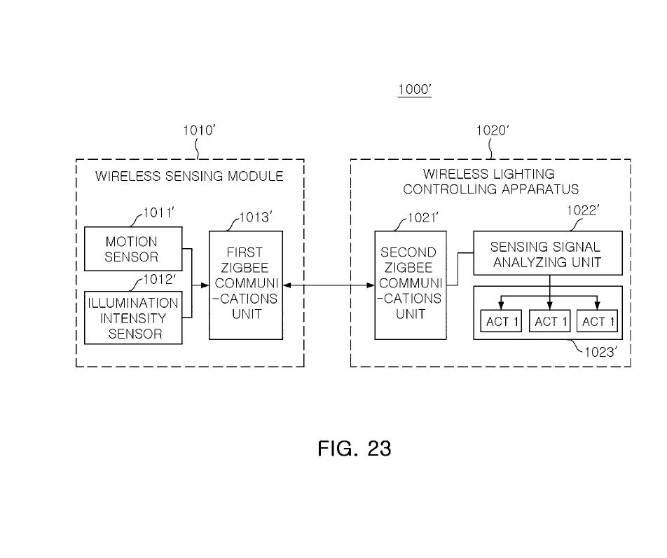

Hereinafter, another example of a lighting system using the foregoing lighting device will be described with reference to FIGS. 23 through 26. The lighting system according to the present embodiment may automatically perform a predetermined control by detecting a motion of a monitored target and an intensity of illumination at a location of the monitored target.

FIG. 23 is a block diagram of a lighting system according to another embodiment of the present disclosure.

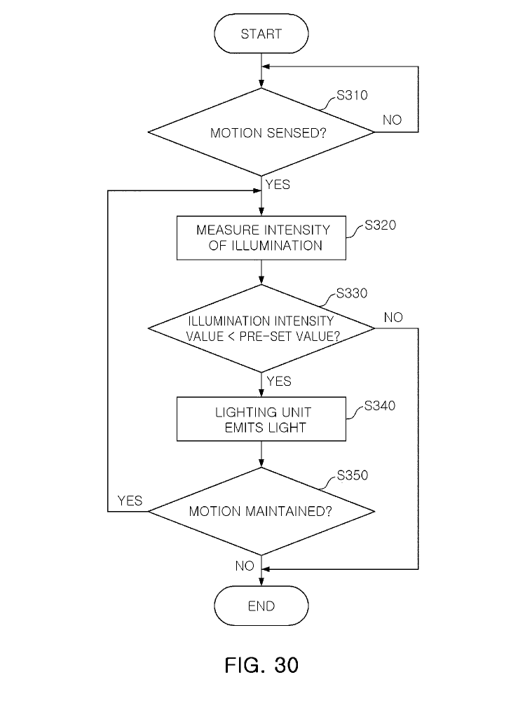

Referring to FIG. 30, a lighting system 1000′ according to the present embodiment may include a wireless sensing module 1010′ and a wireless lighting controlling device 1020′.

The wireless sensing module 1010′ may include a motion sensor 1011′, an illumination intensity sensor 1012′ sensing an intensity of illumination, and a first wireless communications unit generating a wireless signal that includes a motion sensing signal from the motion sensor 1011′ and an illumination intensity sensing signal from the illumination intensity sensor 1012′ and that complies with a predetermined communications protocol, and transmitting the same. The first wireless communications unit may include a first ZigBee communications unit 1013′ generating a ZigBee signal that complies with a pre-set communications protocol and transmitting the same.

The wireless lighting controlling device 1020′ may include a second wireless communications unit receiving the wireless signal from the first wireless communications unit and restoring a sensing signal, a sensing signal analyzing unit 1022′ analyzing the sensing signal from the second wireless communications unit, and an operation control unit 1023′ performing a predetermined control based on analysis results from the sensing signal analyzing unit 1022′. The second wireless communications unit may be configured as a second ZigBee communications unit 1021′ receiving the ZigBee signal from the first ZigBee communications unit 1013′ and restoring a sensing signal.

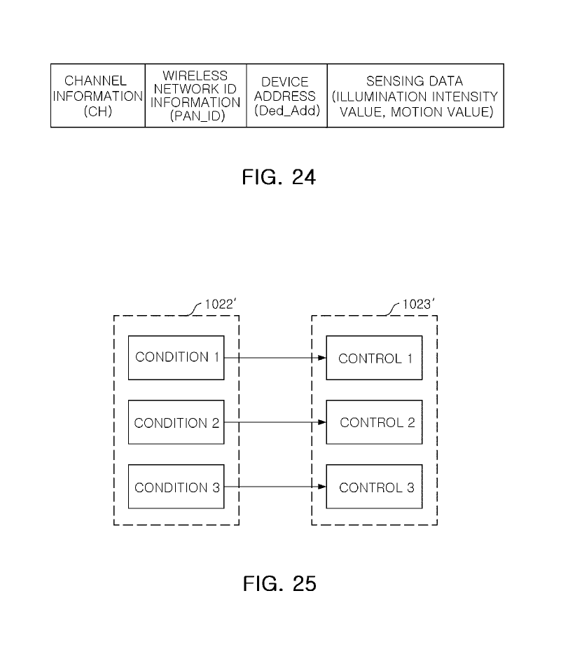

FIG. 24 is a view illustrating a format of a ZigBee signal according to an embodiment of the present disclosure.

Referring to FIG. 24, the ZigBee signal from the first ZigBee communications unit 1013′ may include channel information (CH) defining a communications channel, wireless network identification (ID) information (PAN_ID) defining a wireless network, a device address (Ded_Add) designating a target device, and sensing data including the motion and illumination intensity sensing signal.

Also, the ZigBee signal from the second ZigBee communications unit 1021′ may include channel information (CH) defining a communications channel, wireless network identification (ID) information (PAN_ID) defining a wireless network, a device address (Ded_Add) designating a target device, and sensing data including the motion and illumination intensity sensing signal.

The sensing signal analyzing unit 1022′ may analyze the sensing signal from the second ZigBee communications unit 1021′ to detect a satisfied condition, among a plurality of conditions, based on the sensed motion and the sensed intensity of illumination.

Here, the operation control unit 1023′ may set a plurality of controls based on the plurality of conditions that are previously set by the sensing signal analyzing unit 1022′, and perform a control corresponding to the condition detected by the sensing signal analyzing unit 1022′.

FIG. 25 is a view illustrating the sensing signal analyzing unit and the operation control unit according to the embodiment of the present disclosure. Referring to FIG. 25, for example, the sensing signal analyzing unit 1022′ may analyze the sensing signal from the second ZigBee communications unit 1021′ and detect a satisfied condition among first, second, and third conditions (condition 1, condition 2, and condition 3), based on the sensed motion and sensed intensity of illumination.

In this case, the operation control unit 1023′ may set first, second and third controls (control 1, control 2, and control 3) corresponding to the first, second, and third conditions (condition 1, condition 2, and condition 3) previously set by the sensing signal analyzing unit 1022′, and perform a control corresponding to the condition detected by the sensing signal analyzing unit 1022′.

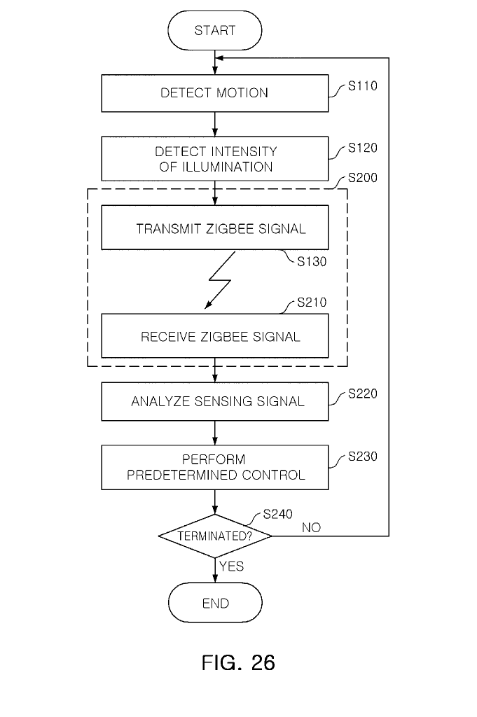

FIG. 26 is a flowchart illustrating an operation of a wireless lighting system according to an embodiment of the present disclosure.

In FIG. 26, in operation 5110, the motion sensor 1011′ detects a motion. In operation 5120, the illumination intensity sensor 1012′ detects an intensity of illumination. Operation 5200 is a process of transmitting and receiving a ZigBee signal. Operation 5200 may include operation 5130 of transmitting a ZigBee signal by the first ZigBee communications unit 1013′ and operation 5210 of receiving the ZigBee signal by the second ZigBee communications unit 1021′. In operation 5220, the sensing signal analyzing unit 1022′ analyzes a sensing signal. In operation 5230, the operation control unit 1023′ performs a predetermined control. In operation 5240, whether the lighting system is terminated is determined.

Operations of the wireless sensing module and the wireless lighting controlling device according to an embodiment of the present disclosure will be described with reference to FIGS. 23 through 26.

First, with reference to FIGS. 23, 24, and 26, the wireless sensing module 1010′ of the wireless lighting system according to an embodiment of the present disclosure will be described. The wireless lighting system 1010′ according to the present embodiment can be installed in a location in which a lighting device is installed, to detect a current intensity of illumination of the lighting device and detect human motion near the lighting device.

Namely, the motion sensor 1011′ of the wireless sensing module 1010′ can be configured as an infrared sensor, or the like, capable of sensing a human. The motion sensor 1010′ senses a motion and provides the same to the first ZigBee communications unit 1013′ (S110 in FIG. 26). The illumination intensity sensor 1012′ of the wireless sensing module 1010′ senses an intensity of illumination and provides the same to the first ZigBee communications unit 1013′ (S120).

Accordingly, the first ZigBee communications unit 1013′ generates a ZigBee signal that includes the motion sensing signal from the motion sensor 1010′ and the illumination intensity sensing signal from the illumination intensity sensor 1012′ and that complies with a pre-set communications protocol, and transmits the generated ZigBee signal wirelessly (S130).

Referring to FIG. 24, the ZigBee signal from the first ZigBee communications unit 1013′ may include channel information (CH) defining a communications channel, wireless network identification (ID) information (PAN_ID) defining a wireless network, a device address (Ded_Add) designating a target device, and sensing data, and here, the sensing data includes a motion value and an illumination intensity value.

Next, the wireless lighting controlling device 1020′ of the wireless lighting system according to an embodiment of the present disclosure will be described with reference to FIGS. 23 through 26. The wireless lighting controlling device 1020′ of the wireless lighting system according to the present embodiment may control a predetermined operation according to an illumination intensity value and a motion value included in a ZigBee signal from the wireless sensing module 1010′.

Namely, the second ZigBee communications unit 1021′ of the wireless lighting controlling device 1020′ according to the present embodiment receives the ZigBee signal from the first ZigBee communications unit 1013′, restores a sensing signal therefrom, and provides the restored sensing signal to the sensing signal analyzing unit 1020′ (S210 in FIG. 26).

Referring to FIG. 24, the ZigBee signal from the second ZigBee communications unit 1021′ may include channel information (CH) defining a communications channel, wireless network identification (ID) information (PAN_ID) defining a wireless network, a device address (Ded_Add) designating a target device, and sensing data. A wireless network may be identified based on the channel information (CH) and the wireless network ID information (PAN_ID), and a sensed device may be recognized based on the device address. The sensing data includes a motion value and an illumination intensity value.

Also, referring to FIG. 23, the sensing signal analyzing unit 1022′ analyzes the illumination intensity value and the motion value included in the sensing signal from the second ZigBee communications unit 1021′ and provides the analysis results to the operation control unit 1023′ (S220 in FIG. 26).

Accordingly, the operation control unit 1023′ may perform a predetermined control according to the analysis results from the sensing signal analyzing unit 1022′ (S230).

The sensing signal analyzing unit 1022′ may analyze the sensing signal from the second ZigBee communications unit 1021′ and detect a satisfied condition, among a plurality of conditions, based on the sensed motion and the sensed intensity of illumination. Here, the operation control unit 1023′ may set a plurality of controls corresponding to the plurality of conditions set in advance by the sensing signal analyzing unit 1022′, and perform a control corresponding to the condition detected by the sensing signal analyzing unit 1022′.

For example, referring to FIG. 25, the sensing signal analyzing unit 1022′ may detect a satisfied condition among the first, second, and third conditions P (condition 1, condition 2, and condition 3) based on the sensed motion and the sensed intensity of illumination by analyzing the sensing signal from the second ZigBee communications unit 1021′.

In this case, the operation control unit 1023′ may set first, second, and third controls (control 1, control 2, and control 3) corresponding to the first, second, and third conditions (condition 1, condition 2, and condition 3) set in advance by the sensing signal analyzing unit 1022′, and perform a control corresponding to the condition detected by the sensing signal analyzing unit 1022′.

For example, when the first condition (condition 1) corresponds to a case in which human motion is sensed at a front door and an intensity of illumination at the front door is not low (not dark), the first control may turn off all predetermined lamps. When the second condition (condition 2) corresponds to a case in which human motion is sensed at the front door and an intensity of illumination at the front door is low (dim), the second control may turn on some pre-set lamps (i.e., some lamps at the front door and some lamps in a living room). When the third condition (condition 3) corresponds to a case in which human motion is sensed at the front door and an intensity of illumination at the front door is very low (a very dark environment), the third control may turn on all the pre-set lamps.

Unlike the foregoing cases, besides the operation of turning lamps on or off, the first, second, and third controls may be variously applied according to pre-set operations. For example, the first, second, and third controls may be associated with operations of a lamp and an air-conditioner in summer or may be associated with operations of a lamp and heating in winter.

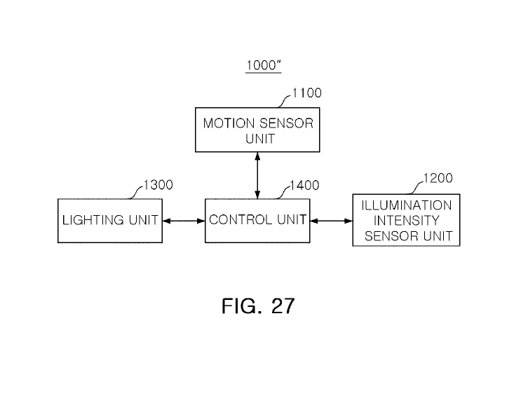

Other examples of a lighting system will be described with reference to FIGS. 27 through 30.

FIG. 27 is a block diagram schematically illustrating constituent elements of a lighting system according to another embodiment of the present disclosure.

A lighting system 1000″ according to the present embodiment may include a motion sensor unit 1100, an illumination intensity sensor unit 1200, a lighting unit 1300, and a control unit 1400.

The motion sensor unit 1100 senses a motion of an object. For example, the lighting system may be attached to a movable object, such as, for example, a container or a vehicle, and the motion sensor unit 1100 senses a motion of the moving object. When the motion of the object to which the lighting system is attached is sensed, the motion sensor unit 1100 outputs a signal to the control unit 1400 and the lighting system is activated. The motion sensor unit 1100 may include an accelerometer, a geomagnetic sensor, or the like.

The illumination intensity sensor unit 1200, a type of optical sensor, measures an intensity of illumination of a surrounding environment. When the motion sensor unit 1100 senses the motion of the object to which the lighting system is attached, the illumination intensity sensor unit 1200 is activated according to a signal output by the control unit 1400. The lighting system illuminates during night work or in a dark environment to call a worker or an operator's attention to their surroundings, and allows a driver to secure visibility at night. Thus, even when the motion of the object to which the lighting system is attached is sensed, if an intensity of illumination higher than a predetermined level is secured (during the day), the lighting system may not be required to illuminate. Also, even in the daytime, if it rains, the intensity of illumination may be fairly low, so there is a need to inform a worker or an operator about a movement of a container, and thus, the light emitting unit is required to emit light. Thus, whether to turn on the lighting unit 1300 is determined according to an illumination intensity value measured by the illumination intensity sensor unit 1200.

The illumination intensity sensor unit 1200 measures an intensity of illumination of a surrounding environment and outputs the measured value to the control unit 1400. In an embodiment, when the illumination intensity value is equal to or higher than a pre-set value, the lighting unit 1300 may not be required to emit light, so the overall system is terminated.

When the illumination intensity value measured by the illumination intensity sensor unit 1200 is lower than the pre-set value, the lighting unit 1300 emits light. The worker or the operator may recognize the light emissions from the lighting unit 1300 to recognize the movement of the container, or the like. As the lighting unit 1300, the foregoing lighting device may be employed.

Also, the lighting unit 1300 may adjust intensity of light emissions thereof according to the illumination intensity value of the surrounding environment. When the illumination intensity value of the surrounding environment is low, the lighting unit 1300 may increase the intensity of light emissions thereof, and when the illumination intensity value of the surrounding environment is relatively high, the lighting unit 1300 may decrease the intensity of light emissions thereof, thus preventing power wastage.

In an embodiment, the control unit 1400 controls the motion sensor unit 1100, the illumination intensity sensor unit 1200, and the lighting unit 1300 overall. When the motion sensor unit 1100 senses the motion of the object to which the lighting system is attached, and outputs a signal to the control unit 1400, the control unit 1400 outputs an operation signal to the illumination intensity sensor unit 1200. The control unit 1400 receives an illumination intensity value measured by the illumination intensity sensor unit 1200 and determines whether to turn on (operate) the lighting unit 1300.

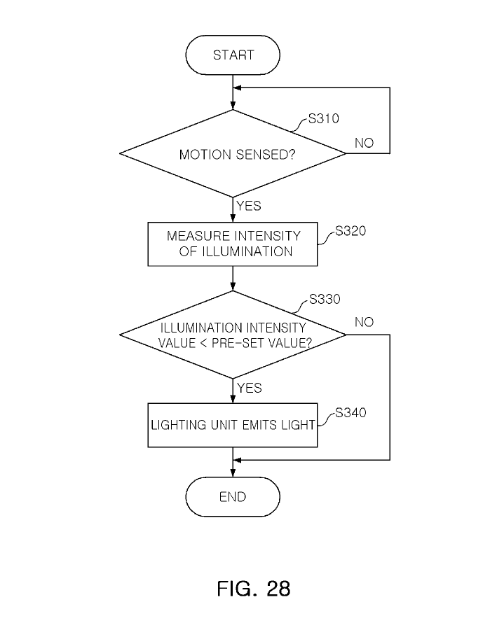

FIG. 28 is a flowchart illustrating a method for controlling a lighting system. Hereinafter, a method for controlling a lighting system will be described with reference to FIG. 28.

First, a motion of an object to which the lighting system is attached is sensed and an operation signal is output (S310). For example, the motion sensor unit 1100 may sense a motion of a container or a vehicle in which the lighting system is installed, and when the motion of the container or the vehicle is sensed, the motion sensor unit 1100 outputs an operation signal. The operation signal may be a signal for activating overall power. Namely, when the motion of the container or the vehicle is sensed, the motion sensor unit 1100 outputs the operation signal to the control unit 1400.

Next, based on the operation signal, an intensity of illumination of a surrounding environment is measured and an illumination intensity value is output (S320). When the operation signal is applied to the control unit 1400, the control unit 1400 outputs a signal to the illumination intensity sensor unit 1200, and then the illumination intensity sensor unit 1200 measures the intensity of illumination of the surrounding environment. The illumination intensity sensor unit 1200 outputs the measured illumination intensity value of the surrounding environment to the control unit 1400. Thereafter, whether to turn on the light emitting unit is determined according to the illumination intensity value and the light emitting unit emits light according to the determination.

First, the illumination intensity value is compared with a pre-set value for a determination (S330). When the illumination intensity value is input to the control unit 1400, the control unit 1400 compares the received illumination intensity value with a stored pre-set value and determines whether the former is lower than the latter. Here, the pre-set value is a value for determining whether to turn on the lighting device. For example, the pre-set value may be an illumination intensity value at which a worker or a driver may have difficulty in recognizing an object with the naked eye or may make a mistake in a situation, for example, a situation in which the sun starts to set.

When the illumination intensity value measured by the illumination intensity sensor unit 1200 is higher than the pre-set value, lighting of the light emitting unit is not required, so the control unit 1400 shuts down the overall system.

In an embodiment, when the illumination intensity value measured by the illumination intensity sensor unit 1200 is lower than the pre-set value, lighting of the light emitting unit is required, so the control unit 1400 outputs a signal to the lighting unit 1300 and the lighting unit 1300 emits light (S340).

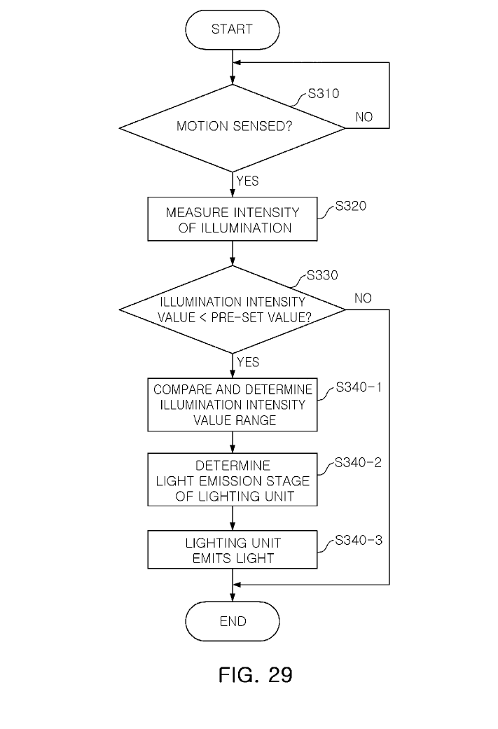

FIG. 29 is a flowchart illustrating a method for controlling a lighting system according to another embodiment of the present disclosure. Hereinafter, a method for controlling a lighting system according to another embodiment of the present disclosure will be described. However, the same procedure as that of the method for controlling a lighting system as described above with reference to FIG. 28 will be omitted.

As illustrated in FIG. 29, in the case of the method for controlling a lighting system according to the present embodiment, an intensity of light emissions of the light emitting unit may be regulated according to an illumination intensity value of a surrounding environment.

As described above, the illumination intensity sensor unit 1200 outputs an illumination intensity value to the control unit 1400 (S320). When the illumination intensity value is lower than a pre-set value (S330), the control unit 1400 determines a range of the illumination intensity value (S340-1). The control unit 1400 has a range of subdivided illumination intensity value, based on which the control unit 1400 determines the range of the measured illumination intensity value.

Next, when the range of the illumination intensity value is determined, the control unit 1400 determines an intensity of light emissions of the light emitting unit (S340-2), and accordingly, the lighting unit 1300 emits light (S340-3). The intensity of light emissions of the light emitting unit may be divided according to the illumination intensity value, and here, the illumination intensity value varies according to weather, time, and surrounding environment, so the intensity of light emissions of the light emitting unit may also be regulated. By regulating the intensity of light emissions according to the range of the illumination intensity value, power wastage may be prevented and a worker or an operator's attention may be drawn to their surroundings.

FIG. 30 is a flowchart illustrating a method for controlling a lighting system according to another embodiment of the present disclosure. Hereinafter, a method for controlling a lighting system according to another embodiment of the present disclosure will be described. However, the same procedure as that of the method for controlling a lighting system as described above with reference to FIGS. 28 and 29 will be omitted.

In an embodiment, the method for controlling a lighting system according to the present embodiment further includes operation 5350 of determining whether a motion of an object to which the lighting system is attached is maintained in a state in which the lighting unit 1300 emits light, and determining whether to maintain light emissions.

First, when the lighting unit 1300 starts to emit light, termination of the light emissions may be determined based on whether a container or a vehicle to which the lighting system is installed moves. Here, when the motion of the container is stopped, it may be determined that an operation thereof has terminated. In addition, when a vehicle temporarily stops at a crosswalk, light emissions of the light emitting unit may be stopped to prevent interference with the vision of oncoming drivers.

When the container or the vehicle moves again, the motion sensor unit 1100 operates and the lighting unit 1300 may start to emit light.

In an embodiment, whether to maintain light emissions may be determined based on whether a motion of an object to which the lighting system is attached is sensed by the motion sensor unit 1100. When the motion of the object is continuously sensed by the motion sensor unit 1100, an intensity of illumination is measured again and whether to maintain light emissions is determined. In an embodiment, when the motion of the object is not sensed, the system is terminated.

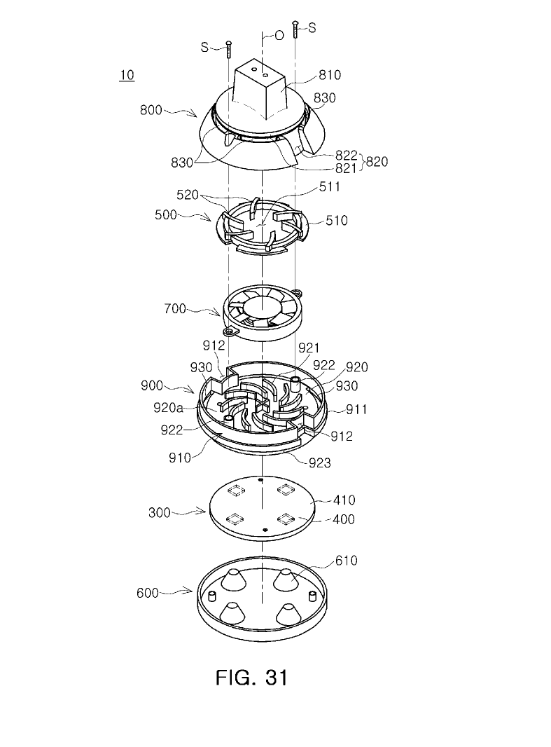

A lighting device according to an embodiment of the present disclosure will be described with reference to FIGS. 31 to 33.

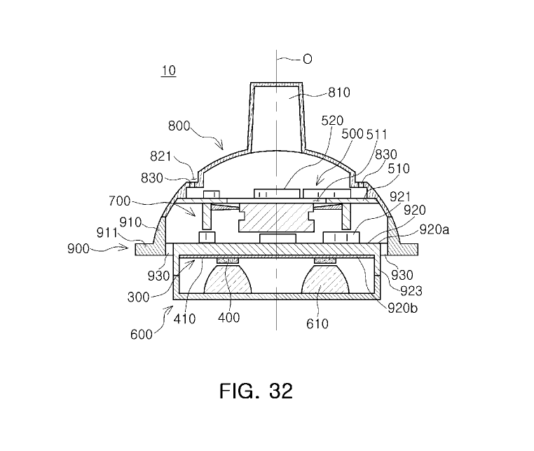

FIG. 31 is an exploded perspective view schematically illustrating a lighting device according to an embodiment of the present disclosure, and FIG. 32 is a cross-sectional view schematically illustrating a lighting device according to an embodiment of the present disclosure. In FIGS. 31 and 32, a lamp according to the MR16 standard is illustrated as a lighting device according to the present embodiment, but the lighting device according to an embodiment of the present disclosure is not limited thereto.

Referring to FIGS. 31 and 32, a lighting device 10 according to the present embodiment may include a base 900, a housing 800, a cooling fan 700, and a light emitting unit 300.

The base 900 is a type of a frame member in which the cooling fan 700 and the light emitting unit 300 are fixedly installed. The base 900 may include a fastening rim 910 and a support plate 920 provided within the fastening rim 910.

The fastening rim 910 may have an annular structure perpendicular with respect to a central axis O, and may have a flange portion 911 protruded from a lower end portion of the flange portion 911 in an outward direction. When the lighting device 10 is installed in a structure such as a ceiling, the flange portion 911 may be inserted into a hole provided in the ceiling to serve to fix the lighting device 10.

The fastening rim 910 may have a recess 912 formed to be depressed in a direction toward a central portion of the base 900. The recess 912 may have a shape corresponding to that of a flow path 920 of a housing 800 as described hereinafter, and may be formed in a position corresponding to the flow path 920. Accordingly, the flow path 920 is formed with the recess 912 in a continued manner, so as to be exposed outwardly through a lower portion of the fastening film 910.

The base 900 employed in the present embodiment will be described in detail. The support plate 920 may be provided on an inner circumferential surface of the fastening rim 910 and have a horizontal structure perpendicular with respect to the central axis O and may be partially connected to the fastening rim 910. The support plate 920 may have one surface (or an upper surface) 920a and the other surface (or a lower surface) 920b which are flat and opposed to each other, and may include a plurality of heat dissipation fins 921 formed on one surface 920a thereof. The plurality of heat dissipation fins 921 may be arranged radially from the center of the support plate 920 toward the edges thereof. In this case, the plurality of heat dissipation fins 921 may have a curved surface, respectively, and have an overall spiral shape. In the present embodiment, it is illustrated that the plurality of heat dissipation fins 921 each having a curved surface are arranged in a spiral manner, but the present inventive concept is not limited thereto and the heat dissipation fins 921 may have any other various shapes such as a linear shape, and the like.

Fixing portions 922 may be formed to be protruded to a predetermined height from the one surface 920a. The fixing portions 922 may have a screw hole formed therein to allow the housing 800 and the cooling fan 700 as described hereafter to be fixed thereto through fixing units such as screws S, or the like.

The light emitting unit 300 is installed on the other surface 920b of the support plate 920. A side wall 923 protruded from the other surface 920b in a downward direction and having a predetermined height may be provided along the circumference of the edges. A space having a predetermined size may be provided within the side wall 923 to accommodate the light emitting unit 300 therein.

An air discharge hole 930 in the form of a slit may be provided between an outer circumferential surface of the support plate 920 and an internal surface of the fastening rim 910. The air discharge hole 930 may serve as a passage through which air is released from the one surface 920a toward the other surface 920b, and thus, air may not be stagnant in the one surface 920a and a continuous air flow may be maintained.

The base 900 is a part directly in contact with the light emitting unit 300 as a heat source, so it may be made of a material having excellent heat conductivity to perform a heat dissipation function such as that of a heat sink. For example, the base 900 may be formed of a metal, a resin, or the like, having excellent heat conductivity through injection molding, or the like, such that the fastening rim 910 and the support plate 920 are integrated. Also, the fastening rim 910 and the support plate 920 may be fabricated as separate components and assembled. In this case, the support plate 920 may be made of a metal, a resin, or the like, having excellent heat conductivity, and the fastening rim 910 that the user directly grasps in case of an operation such as replacement of a lighting device, or the like, may be made of a material having relatively low heat conductivity in order to prevent damage due to a burn.

As illustrated in FIGS. 31 and 32, the housing 800 may be disposed on one side of the base 900. In detail, the housing 800 is fastened to the fastening rim 910 to cover the support plate 920. The housing 800 may have an upwardly convex parabolic shape, and a terminal portion 810 is provided in an upper end portion of the housing 800 and fastened to an external power source (e.g., a socket), and an opening may be formed in a lower end portion of the external power source and fastened to the base 900. In particular, the housing 800 may include the flow path 820 as a depressed region forming a step with respect to an external surface of the housing 800 to guide an inflow of air from the outside and an air inflow hole 830 allowing air guided through the flow path 820 to be introduced to an internal surface.

The air inflow hole 830 may have an annular shape along the circumference of the housing 800 and may be adjacent to an upper end portion of the housing 800. At least one flow path 820 may have a depressed structure in the form of a recess and may be formed on an outer surface of the housing 800. The flow path 820 may extend upwardly along the outer surface of the housing 800 to communicate with the air inflow hole 830.

In detail, the flow path 820 may include a first flow path 821 formed along the circumference of the housing 800 in a position corresponding to the air inflow hole 830 to communicate with the air inflow hole 830 and a second flow path 822 extending from the first flow path 821 to a lower end portion of the housing 800 so as to be opened outwards. The second flow path 822 may be formed with the recess 912 of the fastening rim 910 fastened to the lower end portion of the housing 800 in a continued manner, and may extend to a lower portion of the fastening rim 910 so as to be opened outwards. Accordingly, ambient air may be introduced along the flow path 820 as a portion of the outer surface of the housing 800 from a lower side of the fastening rim 910 and guided in an upward direction, and may be introduced to an internal space of the housing 800 through the air inflow hole 830. In the present embodiment, it is illustrated that a pair of second flow paths 822 are provided in a facing manner, but the amount of the second flow paths 822 and positions thereof may be variously modified.

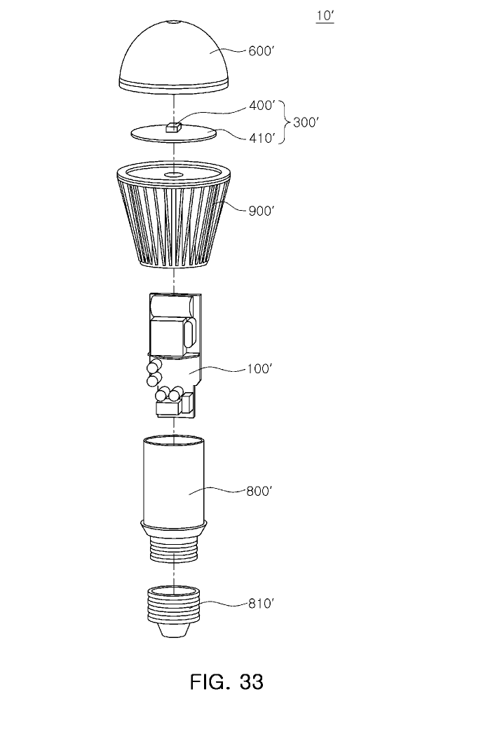

FIG. 33 is an exploded perspective view illustrating an example in which a light emitting device package according to an embodiment of the present disclosure is applied to a lighting device.

Referring to the exploded perspective view of FIG. 33, a lighting device 10′ is illustrated as, for example, a bulb type lamp, including a light emitting unit 300′, a driving unit 100′, and an external connection unit 810′. Also, the lighting device 10′ may further include external structures such as a housing 800′ and a cover unit 600′. The light emitting unit 300′ may include a light emitting element 400′ having the LED package structure or any structure similar thereto and a substrate 410′ on which the light emitting element 400′ is mounted. In the present embodiment, a single light emitting element 400′ is illustrated as being mounted on the substrate 410′, but the present inventive concept is not limited thereto and a plurality of light emitting elements 400′ may be mounted as necessary.

Heat generated by the light emitting element 400′ may be dissipated through a heat dissipation unit, and a heat sink 900′ directly in contact with the light emitting unit 300′ to enhance heat dissipation effect may be included in the lighting device 100′ according to the present embodiment. The cover unit 600′ may be installed on the light emitting unit 300′ to have a convex lens shape. The driving unit 100′ may be installed in the housing 800′ and connected to an external connection unit 810′ having a socket structure to receive power from an external power source. Also, the driving unit 100′ may serve to convert received power into an appropriate current source for driving the light emitting element 400′ included in the light emitting unit 300′ and provide the same. For example, the driving unit 100′ may include the circuits described above with reference to FIGS. 1, 2, 14 to 16, and the like.

Also, the lighting device 10′ may further include the communications module as described above.

The lighting device using an LED as described above may be altered in terms of an optical design thereof according to a product type, a location, and a purpose. For example, in relation to the foregoing sensitivity illumination, a technique for controlling lighting by using a wireless (remote) control technique utilizing a portable device such as a smartphone, in addition to a technique of controlling a color, temperature, brightness, and a hue of illumination (or lighting) may be provided.

Also, in addition, a visible wireless communications technology aimed at achieving a unique purpose of an LED light source and a purpose as a communications unit by adding a communications function to LED lighting devices and display devices may be available. This is because, an LED light source advantageously has a longer lifespan and excellent power efficiency, implements various colors, supports a high switching rate for digital communications, and is available for digital control, in comparison to existing light sources.

The visible light wireless communications technology is a wireless communications technology transferring information wirelessly by using light having a visible light wavelength band recognizable by humans' eyes. The visible light wireless communications technology is discriminated from a wired optical communications technology in the aspect that it uses light having a visible light wavelength band, and discriminated from a wired optical communications technology in the aspect that a communications environment is based on a wireless scheme.

Also, unlike RF wireless communications, the visible light wireless communications technology has excellent convenience and physical security properties in that it can be freely used without being regulated or permitted in the aspect of frequency usage, is differentiated in that a user can check a communications link with his/her eyes, and above all, the visible light wireless communications technology has features as a fusion technique (or converging technology) obtaining a unique purpose as a light source and a communications function.

As set forth above, according to embodiments of the present disclosure, circuit malfunctions due to a ripple component included in an output voltage from the converter can be prevented by using the cut-off circuit having hysteresis characteristics, and stable operations can be secured during the initial driving (start-up) by using the bleeder resistor.

Advantages and effects of the present disclosure are not limited to the foregoing content and any other technical effects not mentioned herein may be easily understood by a person skilled in the art from the foregoing description.

While the present disclosure has been shown and described in connection with the embodiments, it will be apparent to those skilled in the art that modifications and variations can be made without departing from the spirit and scope of the invention as defined by the appended claims.

What is claimed is:

1. A light emitting diode (LED) driving device comprising:
a DC-DC converter configured to generate a driving signal with respect to a plurality of LEDs;
a rectifying unit configured to rectify an alternating current (AC) signal to generate a direct current (DC) signal;
a power factor correction (PFC) converter connected to the rectifying unit; and
a controller configured to detect an output from the DC-DC converter and an output from the PFC converter to determine input impedance of the PFC converter.

2. The LED driving device of claim 1, wherein the controller is configured to determine the input impedance of the PFC converter on the basis of at least one of a level of the output from the PFC converter and a ripple component included in the output from the PFC converter.

3. The LED driving device of claim 2, wherein when the level of the output from the PFC converter or the ripple component included in the output from the PFC converter is increased, the controller reduces the input impedance of the PFC converter, and
when the level of the output from the PFC converter or the ripple component included in the output from the PFC converter is reduced, the controller increases the input impedance of the PFC converter.

4. The LED driving device of claim 1, wherein the controller is configured to determine the input impedance of the PFC converter by adjusting at least one of a switching frequency and a duty ratio of a switching element included in the PFC converter.

5. The LED driving device of claim 1, wherein the controller comprises:
an adding circuit configured to add the output from the PFC converter and a predetermined reference signal; and
a Schmitt Trigger circuit configured to add an operation of the switching element included in the PFC converter by using an output from the adding circuit and an output from the DC-DC converter.

6. The LED driving device of claim 5, wherein a trigger voltage of the Schmitt Trigger circuit is determined by the level of the output from the PFC converter and the ripple component included in the output from the PFC converter.

7. The LED driving device of claim 1, further comprising a diode connected between an output terminal of the PFC converter and an output terminal of the rectifying unit.

8. The LED driving device of claim 1, wherein the AC signal rectified by the rectifying unit is an output signal from a stabilizer including at least one of an electronic transformer and a magnetic transformer.

9. A lighting device comprising:
a light emitting unit including a plurality of light emitting diodes (LEDs);
a transformer configured to output an alternating current (AC) signal;
a converter unit including a power factor correction (PFC) converter connected to an output terminal of the transformer and a DC-DC converter generating a driving signal for operating the plurality of LEDs; and
a controller configured to adjust impedance matching between an input terminal of the PFC converter and the output terminal of the transformer by detecting an output from the PFC converter and a current flowing in the light emitting unit.

10. The lighting device of claim 9, wherein the controller is configured to adjust input impedance of the converter unit on the basis of a level of the output from the PFC converter and a ripple component included in the output from the PFC converter.

11. The lighting device of claim 9, wherein the controller is configured to control the input impedance of the converter unit by controlling at least one of a switching frequency and a duty ratio of a switching element included in the PFC converter.

12. The lighting device of claim 11, wherein the controller comprises:
an adding circuit configured to add the output from the PFC converter and a predetermined reference signal; and
a Schmitt Trigger circuit configured to control an operation of the switching element by using an output from the adding circuit and a current flowing in the light emitting unit.

13. The lighting device of claim 12, wherein a trigger voltage of the Schmitt Trigger circuit is determined by the level of the output from the PFC converter and the ripple component included in the output from the PFC converter.

14. The lighting device of claim 11, wherein when the level of the output from the PFC converter or the ripple component included in the output from the PFC converter is increased, the controller increases a duty ratio of the switching element, and
when the level of the output from the PFC converter or the ripple component included in the output from the PFC converter is reduced, the controller reduces the duty ratio of the switching element.

15. The lighting device of claim 9, further comprising:
a rectifying unit configured to rectify an alternating current (AC) signal output from the transformer; and
a diode connected between an output terminal of the PFC converter and an output terminal of the rectifying unit.

16. A lighting device comprising:
a light emitting unit including a plurality of light emitting diodes (LEDs);
a sensor unit configured to measure one or more of conditions including ambient temperature and humidity for the light emitting unit;
a control unit connected to the sensor unit and configured to store pre-set values including a color temperature and one or more humidity values provided by a user; and
a driving unit controlled by the control unit and configured to supply power to the light emitting unit to implement the color temperature.

17. The lighting device of claim 16, wherein the control unit is configured to compare the measured conditions from the sensor unit with the pre-set values to adjust the color temperature of the light emitting unit.

18. The lighting device of claim 17, wherein when the comparison indicates that the measurement values satisfy the pre-set values, the control unit is configured to maintain a current color temperature for the light emitting unit.

19. The lighting device of claim 17, wherein when the measurement values do not satisfy the pre-set values, the control unit is configured to determine a color temperature corresponding to the pre-set values.

20. The lighting device of claim 19, wherein the control unit is configured to control the driving unit to cause the light emitting unit to be driven at the determined color temperature corresponding to the pre-set values.
